(19) United States
(12) Patent Application Publication
(10) Pub. No.: US 2025/0117040 A1
(43) Pub. Date: Apr. 10, 2025

(54) WEARABLE RECORDING DEVICE FOR WELL-BEING PLATFORM

(71) Applicant: Lotic.ai, Inc., Bee Cave, TX (US)

(72) Inventors: William Welser, IV, Austin, TX (US); Joshua Robles, Blakeslee, PA (US); Trevor Sunderland, Vaughn, WA (US); Jonathan Cohen, Ashland, OR (US)

(21) Appl. No.: 18/908,696

(22) Filed: Oct. 7, 2024

Related U.S. Application Data
(60) Provisional application No. 63/588,187, filed on Oct. 5, 2023.
(60) Provisional application No. 63/588,075, filed on Oct. 5, 2023.

(51) Int. Cl. G06F 1/16

(52) U.S. Cl. CPC G06F 1/163

(57) ABSTRACT

Described are methods, platforms, systems, media, and applications for enhancing well-being using a wearable recording device that records a story; applying one or more algorithms to the story to extract semi-structured user context data; applying a first machine learning model to classify one or more of sentiment, intent, habits, patterns, beliefs, and motivations from the user context data, wherein the first machine learning model comprises an unsupervised machine learning model; applying a second machine learning model to identify one or more recommended next actions from at least the user context data, wherein the second machine learning model comprises a supervised learning model; and generating one or more well-being-related insights for the user based at least on the user context data, and one or more of the sentiment, intent, habits, patterns, beliefs, motivations, and one or more recommended next actions to encourage a healthy lifestyle.

### RELATED APPLICATION

This application claims the benefit of U.S. Provisional Application No. 63/588,187, filed on Oct. 5, 2023, and U.S. Provisional Application No. 63/588,075, filed Oct. 5, 2023, the contents of which are incorporated herein by reference in their entirety.

### TECHNICAL FIELD

The present disclosure relates generally to systems and methodologies for enhancing well-being through a wearable recording device. In particular, some implementations may relate to methodologies for receiving an unstructured user-generated narrative or story with a wearable recording device, applying a combination of algorithms and machine learning models to the unstructured user-generated narrative to classify aspects of the unstructured user-generated narrative and provide next actions to a user.

### BACKGROUND

The concept of well-being encompasses a broad range of human experiences and conditions, touching upon the physical, emotional, and mental states of an individual. Well-being often represents a holistic understanding of health that goes beyond the mere absence of disease or injury, and recognizes the complex interplay of various factors that influence a person's overall state of health and happiness. These factors can range from personal and immediate concerns such as stress levels, dietary habits, and physical activity, to broader and more systemic issues like social support networks, environmental conditions, and access to healthcare services. The multifaceted nature of well-being makes it a challenging yet vital area of study and innovation.

In recent years, there has been a societal shift towards prioritizing well-being, with research increasingly focused on identifying and addressing the myriad of factors that can impact an individual's health. This research has illuminated the importance of not just physical health, but also the mental and emotional aspects of well-being. For example, events from an individual's past, ongoing stressors, nutritional intake, motivation levels, physical exercise, sleep quality and quantity, have all found to play crucial roles in determining one's overall well-being.

Parallel to the growing interest in well-being is the rapid advancement of technology, particularly in the field of machine learning. Machine learning may be considered a branch of subcategory of artificial intelligence, and often involves the development of algorithms that enable computer processors to learn from and make predictions or decisions based on data. This technology has revolutionized numerous fields, offering new methods of solving complex problems by identifying patterns and insights in large datasets that might not be immediately apparent to human analysts.

In the context of well-being, machine learning present a promising avenue for enhancing our understanding and management of the factors that influence health. By analyzing large amounts of data on lifestyle environmental conditions, genetic predispositions, and other relevant factors, machine learning algorithms can identify potential risk and recommend personalized strategies for improving individual well-being. This could include suggestions for dietary changes, exercise routines, stress management techniques, and other interventions tailored to unique needs and circumstances of each person.

### SUMMARY

Often the factors that affect the well-being of an individual are not readily apparent to the individual. Present systems and methods lack the ability to efficiently and accurately identify the factors that affect the well-being of a person. The systems and methods are outdated, lack coordinated data and information, and are often removed from community engagement. This creates the need for an individual to often re-explain their symptoms and history to different people over the course of months or years without making progress in improving the well-being of that individual. Barriers can exist with how the individual communicates their thoughts or past and/or professional misunderstandings and/or simply missing what they hear. The professional also cannot easily identify patterns in the individual to accurately and efficiently identify the individual's needs. Further, often the advice that the professionals give to the individual is only marginally helpful to the individual without actually addressing the underlying need.

Embodiments are described herein for systems and methods for improving the well-being of an individual providing a wearable (or attachable) device for recording stories of the individual. The wearable device can be attached to the individual's clothing for easy access by the individual so that the individual can begin recording at any time. The wearable device can also include various security features that can help the individual protect their stories and safety transfer them to a secure server. The wearable device can also seamlessly transfer the files from a memory in the wearable device to a mobile device (e.g., a cell phone), which can then automatically transfer the audio file to a cloud storage via secure methods.

Various embodiments may include a wearable device for recording a story from a user. In some embodiments, the wearable device may include a microphone configured to receive the story in an audio file; a storage medium configured to temporarily store the audio file; a transmitter configured to transmit the audio file to an external device; and if the user opted-in to automatic deletion, a controller configured to automatically erase the audio file from the storage medium after the audio file has been transmitted to the external device.

In some embodiments, the wearable device further comprises an attachment mechanism configured to attach or couple the wearable device to the user, clothing, keychain, or other device held by the user. In some embodiments the attachment mechanism comprises one of a pin, a clip, or a keychain.

In some embodiments, the story is at most about 3 minutes long. In some embodiments, the controller is further configured to receive confirmation that the audio file has been validated. In some embodiments, the validation comprises successfully transferring to the external device and the story being accessible by a platform on or connected to the external device.

In some embodiments, the controller is further configured to automatically erase the audio file after the audio file has been validated if the user has opted-in to automatic deletion. In some embodiments, the controller is further configured to store the audio file after the audio file has been validated if the user has not opted-in to automatic deletion.

In some embodiments, the controller is configured to establish a connection to the external device via Bluetooth. In some embodiments, the wearable device is further configured to operate without the user accessing the external device after the connection is established. In some embodiments, the wearable device further comprises a one or more components configured to provide a cue. In some embodiments, the cue prompts the user to provide the story.

In some embodiments, the cue prompts the user that a battery level of the wearable device is low. In some embodiments, the cue prompts the user that there is a predetermined amount of time remaining in the recording. In some embodiments, the one or more components comprises a speaker configured to provide the cue in audio format. In some embodiments, the one or more components comprises one or more light-emitting diodes (LEDs) configured to provide the cue as a particular pattern or color. In some embodiments, the one or more components comprises a buzzer configured to buzz or vibrate to provide the cue.

In some embodiments, the wearable device further comprises one or more push buttons electrically connected to the controller. In some embodiments, the one or more push buttons includes a first button to initiate the recording and/or end the recording. In some embodiments, the one or more push buttons includes a second button to reset the wearable device. In some embodiments, one of the one or more push buttons Is configured to enable the wearable device to enter a Bluetooth pairing mode to initialize connection to a platform on or connected to the external device.

Another aspect is a method for recording a story from a user using a wearable device, comprising: receiving the story in an audio format; temporarily storing, in a storage medium, the story in an audio file; transmitting the audio file to an external device; and automatically erasing the audio file from the storage medium after the audio file has been transmitted to the external device if the user has opted-in to automatic deletion.

In some embodiments, the method further comprises attaching or coupling, using an attachment mechanism, the wearable device to the user or a clothing or a keychain or other device held by the user. In some embodiments, the attachment mechanism comprises one of a pin, a clip, or a keychain. In some embodiments, the story is at most about 3 minutes long. In some embodiments, the method further comprises receiving confirmation that the audio file has been validated. In some embodiments, the validation comprises successfully transferring to the external device and the story being accessible by a platform on or connected to the external device.

In some embodiments, automatically erasing the audio file after the audio file has been validated. In some embodiments, the method further comprises establishing a connection to the external device via Bluetooth. In some embodiments, the method further comprises operating the wearable device without the user accessing the external device after the connection is established. In some embodiments, the method further comprises providing a cue. In some embodiments, the cue prompts the user to provide the story. In some embodiments, the cue prompts the user that a battery level of the wearable device is low.

In some embodiments, the cue prompts the user that there is a predetermined amount of time remaining in the recording. In some embodiments, the cue is provided in an audio format via one or more speakers. In some embodiments, the cue is provided as a particular pattern or color using one or more light-emitting diodes (LEDs). In some embodiments, the cue 1s provided includes a buzz via a buzzer or vibration. In some embodiments, one or more push buttons electrically connected to the controller.

In some embodiments, the one or more push buttons includes a first button to initiate the recording and/or end the recording. In some embodiments, the one or more push buttons includes a second button to reset the wearable device. In some embodiments, the method further comprises enabling the wearable device to enter a Bluetooth pairing mode to initialize connection to a platform on or connected to the external device.

Another aspect is non-transitory computer-readable media encoded with instructions executable by at least one processor for recording a story from a user using a wearable device that when executed performs a method, the method comprising: receiving the story in an audio format; temporarily storing, in a storage medium, the story in an audio file; transmitting the audio file to an external device; and automatically erasing the audio file from the storage medium after the audio file has been transmitted to the external device if the user has opted-in to automatic deletion.

In some embodiments, the method further comprises attaching or coupling, using an attachment mechanism, the wearable device to the user or a clothing or a keychain or other device held by the user. In some embodiments, the attachment mechanism comprises one of a pin, a clip, or a keychain. In some embodiments, the story is at most about 3 minutes long. In some embodiments, the method further comprises receiving confirmation that the audio file has been validated. In some embodiments, the validation comprises successfully transferring to the external device and the story being accessible by a platform on or connected to the external device.

In some embodiments, automatically erasing the audio file after the audio file has been validated. In some embodiments, retaining the audio file after the audio file has been validated if the user has not opted-in to automatic deletion. In some embodiments, the method further comprises establishing a connection to the external device via Bluetooth. In some embodiments, the method further comprises operating the wearable device without the user accessing the external device after the connection is established. In some embodiments, the method further comprises providing a cue. In some embodiments, the cue prompts the user to provide the story. In some embodiments, the cue prompts the user that a battery level of the wearable device is low. In some embodiments, the cue prompts the user that there is a predetermined amount of time remaining in the recording. In some embodiments, the cue is provided in an audio format via one or more speakers. In some embodiments, the cue is provided as a particular pattern or color using one or more light-emitting diodes (LEDs). In some embodiments, the cue is provided includes a buzz via a buzzer or vibration.

In some embodiments, the method further comprises one or more push buttons electrically connected to the controller. In some embodiments, the one or more push buttons includes a first button to initiate the recording and/or end the recording. In some embodiments, the one or more push buttons includes a second button to reset the wearable device. In some embodiments, the method further comprises enabling the wearable device to enter a Bluetooth pairing mode to initialize connection to a platform on or connected to the external device.

Other features and aspects of the disclosure will become apparent from the following detailed description, taken in conjunction with the accompanying drawings, which illustrate, by way of example, the features in accordance with various embodiments. The summary is not intended to limit the scope of the invention, which is defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 shows a non-limiting example of a computing device; in this case, a device with one or more processors, memory, storage, and a network interface.

FIG. 2 shows a non-limiting example of a web/mobile application provision system; in this case, a system providing browser-based and/or native mobile user interfaces.

FIG. 3 shows a non-limiting example of a cloud-based web/mobile application provision system; in this case, a system comprising an elastically load balanced, auto-scaling web server and application server resources as well as synchronously replicated databases.

FIG. 4A shows a schematic overview of an exemplary system providing a well-being platform comprising associated components and applications.

FIG. 4B shows a schematic overview of an exemplary architecture for providing a well-being platform comprising associated components and applications.

FIG. 4C shows a non-limiting example of a schematic overview of a system for recording stories using a wearable device.

FIG. 4D shows a non-limiting example of a schematic overview of the wearable device.

FIG. 5 shows a non-limiting example of a graphical user interface (GUI) for a recording studio module allowing a user to record an unstructured user-generated narrative; in this case, a GUI displaying a first introduction page of a first topic of what a story is.

FIG. 6 shows a non-limiting example of a GUI for a recording studio module allowing a user to record an unstructured user-generated narrative; in this case, a GUI displaying a prompt page for the first topic.

FIG. 7 shows a non-limiting example of a GUI for a recording studio module allowing a user to record an unstructured user-generated narrative; in this case, a GUI displaying a recording page for the first topic.

FIG. 8 shows a non-limiting example of a GUI for a recording studio module allowing a user to record an unstructured user-generated narrative; in this case, a GUI displaying a second introduction page of a second topic of describing the user.

FIG. 9 shows a non-limiting example of a GUI for a recording studio module allowing a user to record an unstructured user-generated narrative; in this case, a GUI displaying a prompt page of the second topic.

FIG. 10 shows a non-limiting example of a GUI for a recording studio module allowing a user to record an unstructured user-generated narrative; in this case, a GUI displaying a recording page of the third topic.

FIG. 11 shows a non-limiting example of a GUI for a recording studio module allowing a user to record an unstructured user-generated narrative; in this case, a GUI displaying a third introduction page of the third topic of describing the user's family.

FIG. 12 shows a non-limiting example of a GUI for a recording studio module allowing a user to record an unstructured user-generated narrative; in this case, a GUI displaying a prompt page of the third topic.

FIG. 13 shows a non-limiting example of a GUI for a recording studio module allowing a user to record an unstructured user-generated narrative; in this case, a GUI displaying a recording page of the third topic.

FIG. 14 shows a non-limiting example of a GUI for a recording studio module allowing a user to record an unstructured user-generated narrative; in this case, a GUI displaying a fourth introduction page of a fourth topic of describing the expectations.

FIG. 15 shows a non-limiting example of a GUI for a recording studio module allowing a user to record an unstructured user-generated narrative; in this case, a GUI displaying a prompt page of the fourth topic.

FIG. 16 shows a non-limiting example of a GUI for a recording studio module allowing a user to record an unstructured user-generated narrative; in this case, a GUI displaying a recording page of the fourth topic.

FIG. 17 shows a non-limiting example of a GUI for a recording studio module allowing a user to record an unstructured user-generated narrative; in this case, a GUI displaying a fifth introduction page of a fifth topic of describing the user's feelings.

FIG. 18 shows a non-limiting example of a GUI for a recording studio module allowing a user to record an unstructured user-generated narrative; in this case, a GUI displaying a prompt page of the fourth topic.

FIG. 19 shows a non-limiting example of a GUI for a recording studio module allowing a user to record an unstructured user-generated narrative; in this case, a GUI displaying a recording page of the fifth topic.

FIG. 20 shows a non-limiting example of a GUI for a well-being application; in this case, a GUI displaying a splash screen.

FIG. 21 shows a non-limiting example of a GUI for a well-being application; in this case, a GUI displaying an account creation screen.

FIG. 22 shows a non-limiting example of a GUI for a well-being application; in this case, a GUI displaying a data usage information screen providing access to a privacy policy.

FIG. 23 shows a non-limiting example of a GUI for a well-being application; in this case, a GUI displaying a privacy and security consent screen providing access to terms and conditions and a privacy policy.

FIGS. 24-26 show a non-limiting example of a GUI for a well-being application; in this case, a GUI displaying a home screen.

FIG. 27 shows a non-limiting example of a GUI for a well-being application; in this case, a GUI displaying an enhanced human insights (EHi) screen.

FIG. 28 shows a non-limiting example of a GUI for a well-being application; in this case, a GUI displaying an audio and video recording screen.

FIG. 29 shows a non-limiting example of a GUI for a well-being application; in this case, a GUI displaying an exploration screen allowing a user to browse page content.

FIG. 30 shows a non-limiting example of a GUI for a well-being application; in this case, a GUI displaying a profile screen providing access to recorded moments and reviews.

FIG. 31 shows a non-limiting example of a GUI for a well-being application; in this case, a GUI displaying a settings screen.

FIGS. 32-36 show various views of the interior and exterior of the Wisdom Pod.

FIGS. 37-38 show non-limiting examples of the wearable device.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION

Frequently, the elements influencing an individual's well-being are elusive, remaining hidden from one's own awareness. Conventional systems and methodologies fall short in their capacity to pinpoint these determinants efficiently and with precision. Furthermore, the dynamics of well-being and its influencing factors are in constant flux, evolving alongside individual and societal changes. Traditional approaches to assessing well-being suffer from a lack of integrated data, outdated practices, and minimal community interaction, leading to disjointed understandings of an individual's health. This fragmentation often forces individuals to repetitively communicate their symptoms and medical history to various professionals over extended periods, without experiencing significant improvement in their well-being. Further, communication barriers between individuals and healthcare professionals, alongside the professionals' difficulties in identifying patterns and accurately assessing needs, can contribute to the inadequacy of the advice given, which, in many cases, fails to address root causes of the individual's issues.

The present disclosure introduces systems and methods designed to overcome these challenges by more accurately and efficiently unlocking insights to enhance an individual's well-being. Leveraging tailored machine learning models, the disclosed systems and methods can recognize behavioral patterns and derive personalized insights, leading to more meaningful recommendations for a healthier lifestyle, or otherwise improved well-being. By breaking down the existing barriers within conventional frameworks, the disclosed approach may facilitate a more seamless interaction between individuals and health professionals. When necessary, it may also streamline the process of connecting individuals with specialists who can offer further assistance, encouraging a more holistic and effective approach to improving well-being.

Moreover, well-being is not solely an individual concern, but may extend to groups and populations, influenced by shared or similar factors among members. These groups, whether they are part of an organization, involved in a conflict, affected by a natural disaster, or residing in a specific geographic region, may encounter unique challenges to their collective well-being. Like individuals, the well-being of these groups and the common factors affecting them, are subject to change over time. Recognizing and addressing the shared aspects of well-being within these communities can lead to more targeted and effective interventions, enhancing the overall health and resilience of the group. This perspective underscores the importance of adaptive and inclusive systems that can cater not only to individual needs but also to the collective well-being of larger communities.

Turning now to the disclosure. In certain embodiments, as described herein, computer-implemented methods may be introduced that include a series of steps aimed at enhancing user well-being through an analysis of user-generated narratives. Initially, these methods may involve the reception of media that includes narratives created by users, which are inherently unstructured. Following this, algorithms may be applied to the narratives to transform them into semi-structured data that can reflect the context from which the user is speaking. The next phase may include the use of a first machine learning model, which may be an unsupervised model, to delve into the semi-structured user context data. This model may classify various elements such as sentiment, intent, patterns, beliefs, and motivations that may be present in the data.

After these elements have been classified, a second machine learning model, which may be a supervised model, may be employed. The role of this model may be to identify recommended actions based on the insights gained from the analysis of the user context data. The culmination of this process may be the generation of insights related to the well-being of the user. These insights may be drawn from an extensive analysis that may include the semi-structured user context data, the classified sentiments, intents, patterns, beliefs, motivations, and the recommended next actions.

Furthermore, systems disclosed herein may include a computing device equipped with at least one processor. The device may be programmed with instructions that, when executed, enable it to perform operations that include receiving unstructured user-generated narratives and applying algorithms to these narratives to produce semi-structured user context data. The systems also may include the use of both an unsupervised and supervised machine learning models to classify user data and identify actionable recommendations, respectively. Finally, the system may generate well-being-related insights for the user by integrating the analysis of user context data with the outcomes of the machine learning models.

Additionally, certain embodiments disclosed herein may include non-transitory computer-readable storage media that includes instructions that, when executed by at least on processor, initiate a well-being application further including several modules. These modules may include, a recording studio module designed for capturing media that can include unstructured user narratives; a user context extraction module that may apply algorithms to these narratives, converting them into semi-structured user context data; a wisdom engine module that can apply the steps of: applying a first unsupervised machine learning model to classify emotional and cognitive elements within the data, followed by a second supervised machine learning model that can identify recommended actions based on the analysis; and lastly, an insight generation module that can synthesize well-being-related insights for the user, drawing on the comprehensive analysis of user context data, emotional and cognitive patterns, and suggested next steps.

In further embodiments, described herein are wearable devices for recording a story from a user, comprising: a microphone configured to receive the story in an audio file; a storage medium configured to temporarily store the audio file; a transmitter configured to transmit the audio file to an external device; and if the user has opted-in to automatic deletion, a controller configured to automatically erase the audio file from the storage medium after the audio file has been transmitted to the external device.

Also described herein, in certain embodiments, are methods for recording a story from a user using a wearable device, comprising: receiving a story in an audio format; temporarily storing, in a storage medium, the story in an audio file; transmitting the audio file to an external device; and automatically erasing the audio file from the storage medium after the audio file has been transmitted to the external device if the user has opted-in to automatic deletion.

Further described herein, in certain embodiments, are non-transitory computer-readable storage media encoded with instructions executable by at least one processor for recording a story for a user using a wearable device that when executed performs a method, the method comprising: receiving the story in an audio format; temporarily storing, in a storage medium, the story in an audio file; transmitting the audio file to an external device; and automatically erasing the audio file from the storage medium after the audio file has been transmitted to the external device if the user has opted-in to automatic deletion.

The present disclosure, as discussed below, may be detailed separately as various features for clarity. These features may include a: computing system, non-transitory computer readable storage medium (CRM), computer program, web application, mobile application, standalone application, web browser plug-in, software modules, databases, generating insights and recommended next actions, distributed ledger technology, machine learning modules, large language models, insights platform (or insight engine), systems for recording stories, wearable device, file transfer and erasure, sensor data, security and privacy, example wearable device workflow, exemplary embodiments, exemplary use cases, and wisdom pod. These component features may be implemented alone or as a combination thereof.

### Computing System

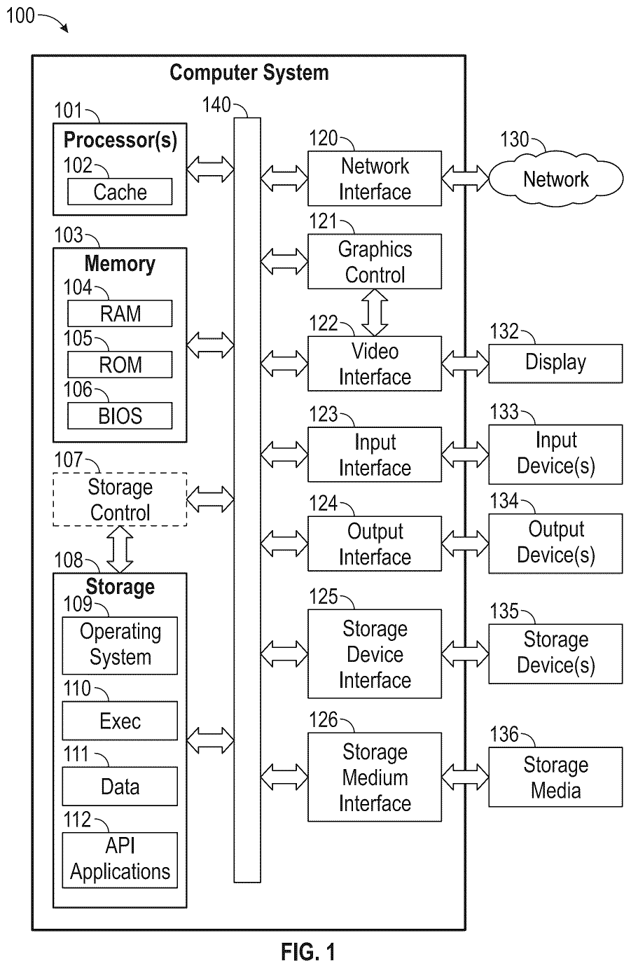

Referring to FIG. 1, a block diagram is shown depicting an exemplary machine that includes a computer system 100 (e.g., a processing or computing system) within which a set of instructions can execute for causing a device to perform or execute any one or more of the aspects and/or methodologies for static code scheduling of the present disclosure. The components in FIG. 1 are examples only and do not limit the scope of use or functionality of any hardware, software, embedded logic component, or a combination of two or more such components implementing particular embodiments.

Computer system 100 may include one or more processors 101, a memory 103, and a storage 108 that communicate with each other, and with other components, via a bus 140. The bus 140 may also link a display 132, one or more input devices 133 (which may, for example, include a keypad, a keyboard, a mouse, a stylus, etc.), one or more output devices 134, one or more storage devices 135, and various tangible storage media 136. All of these elements may interface directly or via one or more interfaces or adaptors to the bus 140. For instance, the various tangible storage media 136 can interface with the bus 140 via storage medium interface 126. Computer system 100 may have any suitable physical form, including but not limited to, one or more integrated circuits (ICs), printed circuit boards (PCBs), mobile handheld devices (such as mobile telephones or PDAs), laptop or notebook computers, distributed computer systems, computing grids, or servers.

Computer system 100 may include one or more processor(s) 101 (e.g., central processing units (CPUs), general purpose graphics processing units (GPGPUs), or quantum processing units (QPUs)) that carry out functions. Processor(s) 101 may optionally contain a cache memory unit 102 for temporary local storage of instructions, data, or computer addresses. Processor(s) 101 may be configured to assist in execution of computer readable instructions. Computer system 100 may provide functionality for the components depicted in FIG. 1 as a result of the processor(s) 101 executing non-transitory, processor-executable instructions embodied in one or more tangible computer-readable storage media, such as memory 103, storage 108, storage devices 135, and/or storage medium 136. The computer-readable media may store software that implements particular embodiments, and processor(s) 101 may execute the software. Memory 103 may read the software from one or more other computer-readable media (such as mass storage device(s) 135, 136) or from one or more other sources through a suitable interface, such as network interface 120. The software may cause processor(s) 101 to carry out one or more processes or one or more steps of one or more processes described or illustrated herein. Carrying out such processes or steps may include defining data structures stored in memory 103 and modifying the data structures as directed by the software.

The memory 103 may include various components (e.g., machine readable media) including, but not limited to, a random access memory component (e.g., RAM 104) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 105 may act to communicate data and instructions unidirectionally to processor(s) 101, and RAM 104 may act to communicate data and instructions bidirectionally with processor(s) 101. ROM 105 and RAM 104 may include any suitable tangible computer-readable media described below. In one example, a basic input/output system 106 (BIOS), including basic routines that help to transfer information between elements within computer system 100, such as during start-up, may be stored in the memory 103.

Fixed storage 108 is connected bidirectionally to processor(s) 101, optionally through storage control unit 107. Fixed storage 108 provides additional data storage capacity and may also include any suitable tangible computer-readable media described herein. Storage 108 may be used to store operating system 109, executable(s) 110, data 111, applications 112 (application programs), and the like. Storage 108 can also include an optical disk drive, a solid-state memory device (e.g., flash-based systems), or a combination of any of the above. Information in storage 108 may, in appropriate cases, be incorporated as virtual memory in memory 103.

In one example, storage device(s) 135 may be removably interfaced with computer system 100 (e.g., via an external port connector (not shown)) via a storage device interface 125. Particularly, storage device(s) 135 and an associated machine-readable medium may provide non-volatile and/or volatile storage of machine-readable instructions, data structures, program modules, and/or other data for the computer system 100. In one example, software may reside, completely or partially, within a machine-readable medium on storage device(s) 135. In another example, software may reside, completely or partially, within processor(s) 101.

Bus 140 connects a wide variety of subsystems. Herein, reference to a bus may encompass one or more digital signal lines serving a common function, where appropriate. Bus 140 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 100 may also include an input device 133. In one example, a user of computer system 100 may enter commands and/or other information into computer system 100 via input device(s) 133. Examples of an input device(s) 133 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 133 may be interfaced to bus 140 via any of a variety of input interfaces 123 (e.g., input interface 123) including, but not limited to, serial, parallel, game port, USB, FIREWIRE, THUNDERBOLT, or any combination of the above.

In particular embodiments, when computer system 100 is connected to network 130, computer system 100 may communicate with other devices, specifically mobile devices and enterprise systems, distributed computing systems, cloud storage systems, cloud computing systems, and the like, connected to network 130. Communications to and from computer system 100 may be sent through network interface 120. For example, network interface 120 may receive incoming communications (such as requests or responses from other devices) in the form of one or more packets (such as Internet Protocol (IP) packets) from network 130, and computer system 100 may store the incoming communications in memory 103 for processing. Computer system 100 may similarly store outgoing communications (such as requests or responses to other devices) in the form of one or more packets in memory 103 and communicated to network 130 from network interface 120. Processor(s) 101 may access these communication packets stored in memory 103 for processing.

Examples of the network interface 120 include, but are not limited to, a network interface card, a modem, and any combination thereof. Examples of a network 130 or network segment 130 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 130, may employ a wired and/or a wireless mode of communication. In general, any network topology may be used.

Information and data can be displayed through a display 132. Examples of a display 132 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 132 can interface to the processor(s) 101, memory 103, and fixed storage 108, as well as other devices, such as input device(s) 133, via the bus 140. The display 132 is linked to the bus 140 via a video interface 122, and transport of data between the display 132 and the bus 140 can be controlled via the graphics control 121. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOYE VR, Zeiss VR One, Avegant Glyph, Freefly VR headset, and the like. In still further embodiments, the display is a combination of devices such as those disclosed herein.

In addition to a display 132, computer system 100 may include one or more other peripheral output devices 134 including, but not limited to, an audio speaker, a printer, a storage device, and any combinations thereof. Such peripheral output devices may be connected to the bus 140 via an output interface 124. Examples of an output interface 124 include, but are not limited to, a serial port, a parallel connection, a USB port, a FIREWIRE port, a THUNDERBOLT port, and any combinations thereof.

In addition or as an alternative, computer system 100 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One®, Nintendo® Wii®, Nintendo® Wii U®, and Ouya®.

### Non-Transitory Computer Readable Storage Medium (CRM)

In some embodiments, the platforms, systems, media, and methods disclosed herein may include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein may include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APis), computing data structures, and the like, which perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tel, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

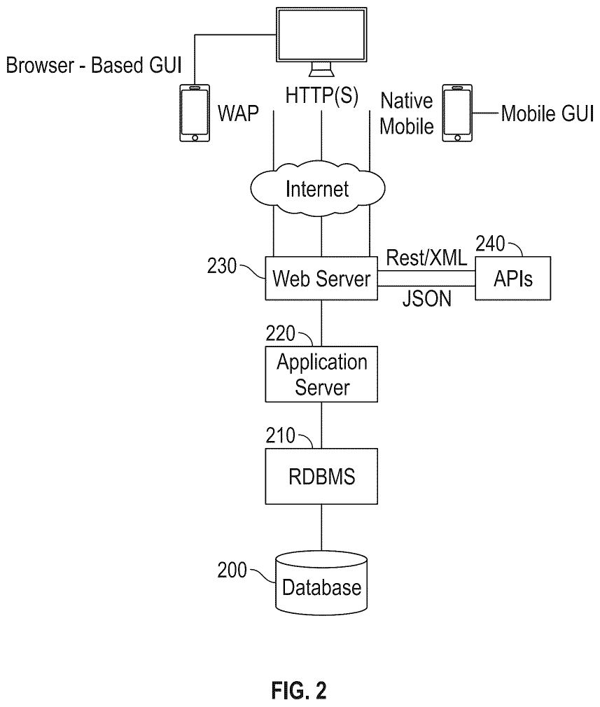

Referring to FIG. 2, in particular embodiments, an application provision system may comprise one or more databases 200 accessed by a relational database management system (RDBMS) 210. Suitable RDBMSs include Firebird, MySQL, PostgreSQL, SQLite, Oracle Database, Microsoft SQL Server, IBM DB2, IBM Informix, SAP Sybase, Teradata, and the like. In such embodiments, the application provision system may further comprise one or more application severs 220 (such as Java servers, .NET servers, PHP servers, and the like) and one or more web servers 230 (such as Apache, IIS, GWS and the like). The web server(s) optionally expose one or more web services via app application programming interfaces (APis) 240. Via a network, such as the Internet, the system provides browser-based and/or mobile native user interfaces.

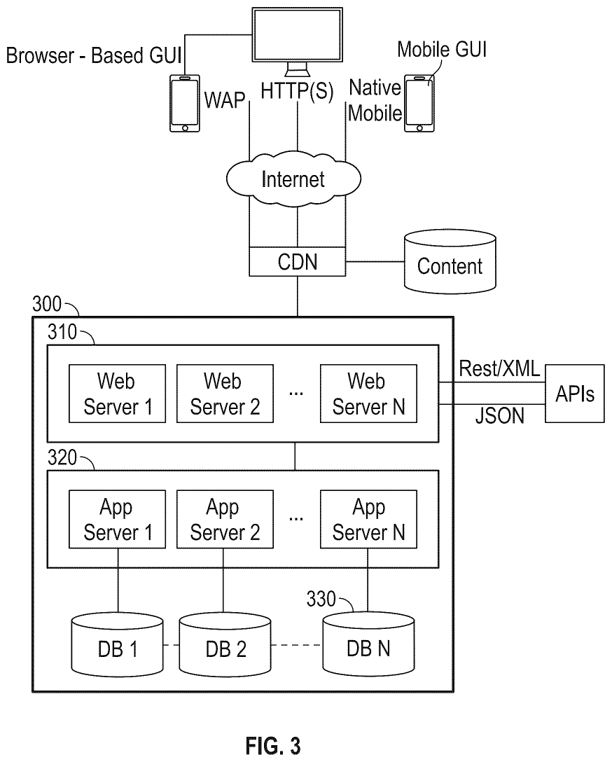

Referring to FIG. 3, in particular embodiments, an application provision system alternatively has a distributed, cloud-based architecture 300 and comprises elastically load balanced, auto-scaling web server resources 310 and application server resources 320 as well synchronously replicated databases 330.

### Mobile Application

In some embodiments, a computer program may include a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application may be created by techniques known to those of skill in the art using hardware, languages, and development environments known to the art. Those of skill in the art will likely recognize that mobile applications are written in several languages. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and PhoneGap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art may recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program may include a standalone application, which may be a program that is run as an independent computer process, not an add-on to an existing process, e.g., not a plug-in. Those of skill in the art may recognize that standalone applications are often compiled. A compiler may be a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable complied applications.

### Web Browser Plug-In

In some embodiments, the computer program may include a web browser plug-in (e.g., extension, etc.). In computing, a plug-in may be one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play videos, generate interactivity, scan for viruses, and display particular file types. Those of skill in the art may be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art may recognize that several plug-in frameworks are available that enable development of plug-ins in various programming languages, including, by way of non-limiting examples, C++, Delphi, Java™, PHP, Python™, and VB.NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM Blackberry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein may include software, server, and/or database modules, or use of the same. In view of the disclosure provided herein, software modules may be created by techniques known to those of skill in the art using machines, software, and languages known to the art. The software modules disclosed herein may be implemented in a multitude of ways. In various embodiments, a software module may comprise a file, a section of code, a programming object, a programming structure, a distributed computing resource, a cloud computing resource, or combinations thereof. In further embodiments, a software module may comprise a plurality of files, a plurality of sections of code, a plurality of programming objects, a plurality of programming structures, a plurality of distributed computing resources, a plurality of cloud computing resources, or combinations thereof. In various embodiments, the one or more software modules may comprise, by way of non-limiting examples, a web application, a mobile application, a standalone application, and a distributed or cloud computing application. In some embodiments, software modules may be in one computer program or application. In other embodiments, software modules may be in more than one computer program or application. In some embodiments, software modules may be hosted on one machine. In other embodiments, software modules may be hosted on more than one machine. In further embodiments, software modules may be hosted on a distributed computing platform such as a cloud computing platform. In some embodiments, software modules may be hosted on one or more machines in one location. In other embodiments, software modules may be hosted on one or more machines in more than one location.

### Databases

In some embodiments, the platforms, systems, media, and methods disclosed herein may include one or more databases, or use of the same. In view of the disclosure provided herein, those of skill in the art may recognize that many databases are suitable for storage and retrieval of, for example, user, media, prompt, summary, curricula, review, survey, check-in, well-being index, token, and marketplace information (data and metadata). In some cases, the data may comprise individual-level data, which may include time-series data for one or more individuals. In some cases, the data may comprise group-level data and/or a population-level data, which may include time-series data for one or more groups and/or populations.

In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing based. In particular embodiments, a database is a distributed database. In other embodiments, a database is based on one or more local computer storage devices.

### Generating Insights and Recommended Next Actions

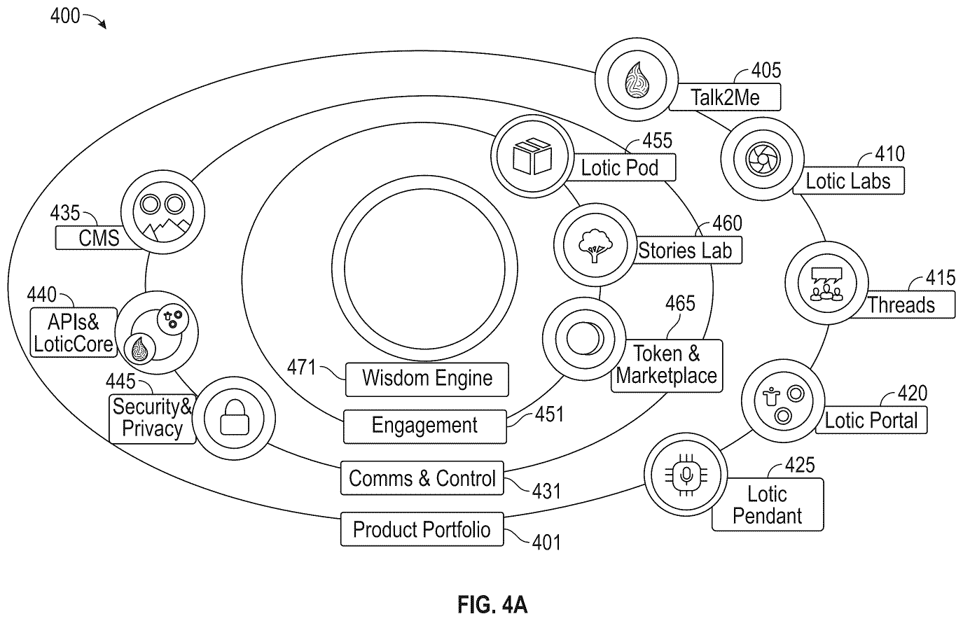

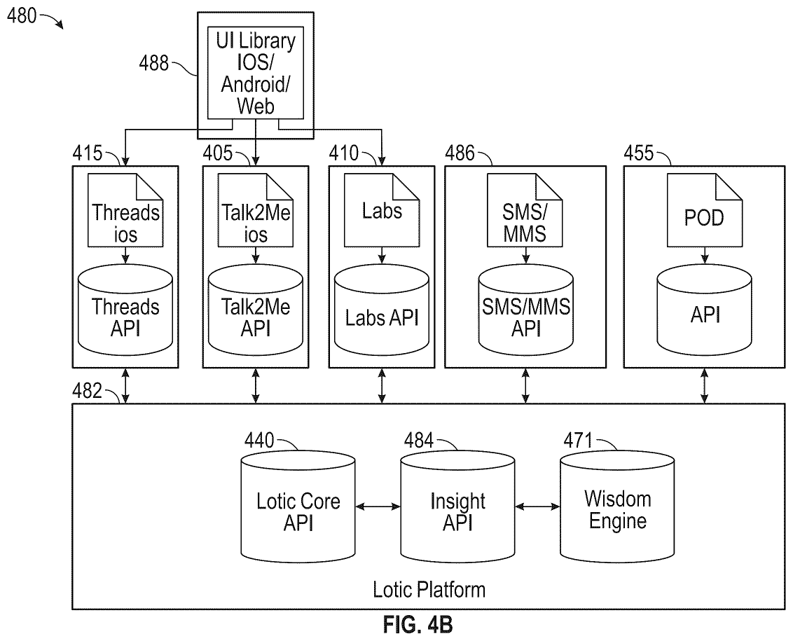

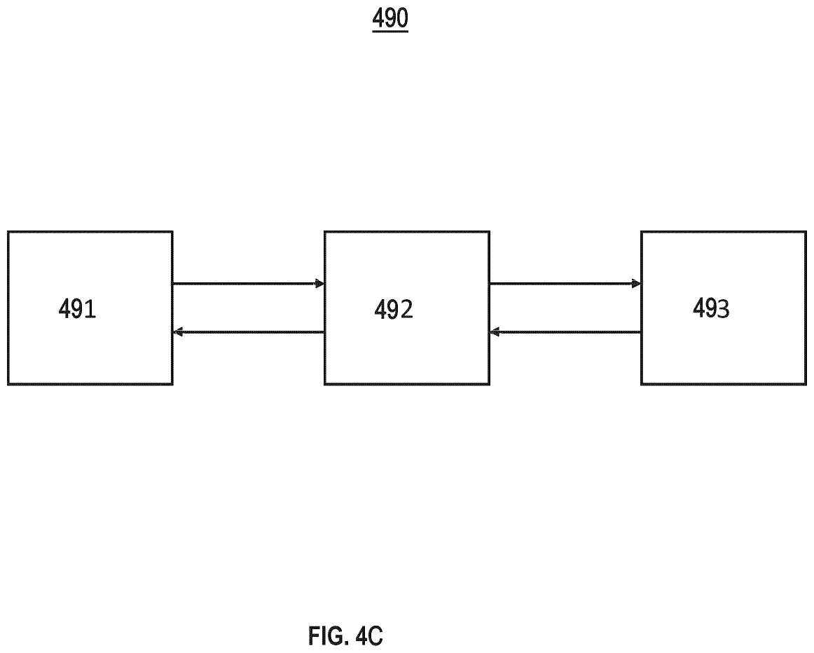

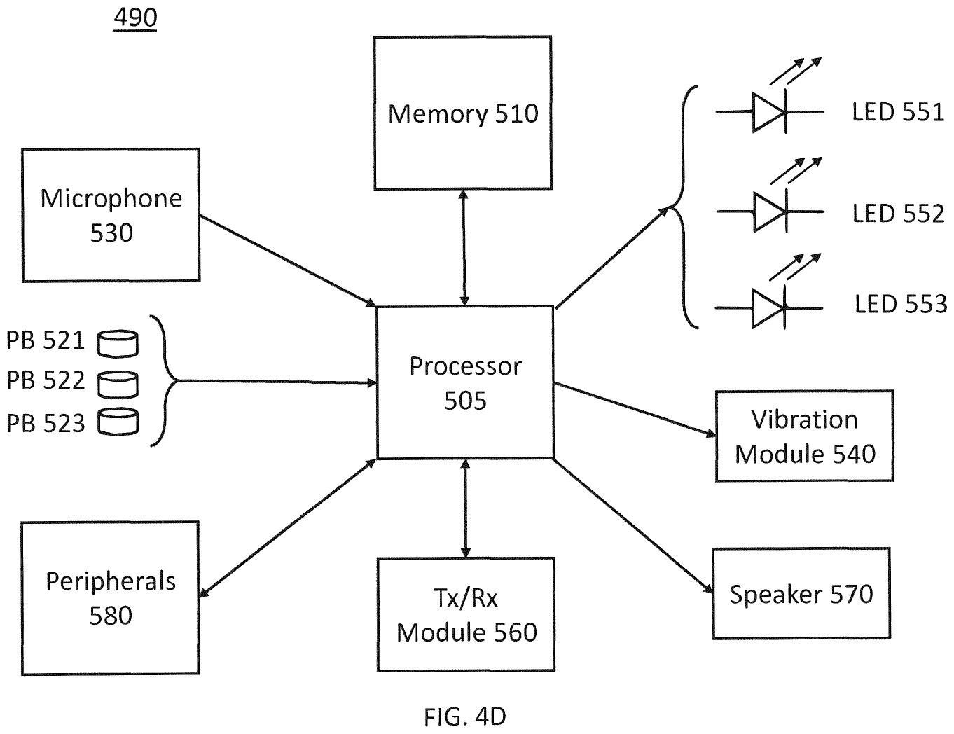

Referring to FIG. 4A, a block diagram of an exemplary system 400 is shown, in accordance with some embodiments. The system 400 of FIG. 4A includes one or more components that can assist in discovering insights in users. The one or more components can include a user application (e.g., Talk2Me™ application) 405, Lotic Labs 410, Threads 415, provider portal (e.g., Lotic Portal™) 420, pairing devices (e.g., Lotic Pendant) 425, content management system (CMS) 435, application programming interfaces (APis) 440, and security and privacy subsystem 445, product portfolio subsystem 401, communications & control subsystem 431, engagement subsystem 451, insight engine (e.g., Wisdom Engine™) 471, Lotic Pod 455, stories workspace (e.g., Stories Lab™) 460, and engagement marketplace (e.g., Token & Marketplace) 465.

In some embodiments, the user application 405 can include a software application that can be installed on an electronic device such as a mobile device, computer, tablet, wearable device, smart glasses, etc. The user application 405 can include a recording tool that a user may access to record audio and/or video disclosures about a topic. The recording can be made in response to a prompt provided by the user application 405 or unprompted (e.g., free response, free form, etc.). In some embodiments, the recording can be saved locally to the device on which the user application 405 is running. In some embodiments, the recording can be streamed to a remote server that can save the recording. In some embodiments, the recording can have any length of time.

In some embodiments, the recording can be transmitted to a server that can analyze the recording. In some embodiments, the recording can be automatically transcribed into text. In some embodiments, the text can be analyzed by one or more machine learning models to provide one or more insights regarding the user.

In some embodiments, the provider portal 420 can provide the ability of healthcare professionals who interact with the users to access user data and information throughout some or all aspects of the care cycle. For example, the healthcare professionals can track symptoms, monitor progress, and provide evidence-based healthcare and resources to the user.

In some embodiments, the pairing devices 425 can generally include custom hardware devices that can pin to the user's clothes. The pairing devices 425 can assist the user in recording the stories that the user shares.

In some embodiments, the product portfolio subsystem 401 can include one or more software modules that may be responsible for managing the user application 405, the Lotic Labs 410, Threads 415, the provider portal, and the pairing devices 425.

In some embodiments, the CMS 435 can include a variety of content that can help the users. For example, the CMS 435 can include curricula, classes, videos, etc. that can help treat and care for the user. The CMS 435 can provide recommendations for the user to take one or more curricula, one or more classes, watch one or more videos, and/or read one or more articles based on the user's insights. Then based on the sensor data of the wearable data and/or whether the user has taken the classes, curricula, watched the videos, and/or read the articles, the CMS 435 can generate a well-being index score of the user that can indicate the quality of the user's well-being.

In some embodiments, the APis 440 can expose functionality of the present disclosure such that third-party developers and affiliates can utilize the information within the system 400.

In some embodiments, the security and privacy subsystem 445 can include encryption functionality that can encrypt the stories, user data, and other information that is used by the system 400. Furthermore, the security and privacy subsystem 445 can be responsible for managing user accounts and identities for the system 400.

In some embodiments, the communications & control subsystem 431 can include one or more software modules that are responsible for managing the CMS 435, the APis 440, and security and privacy subsystem 445.

In some embodiments, the stories workspace 460 can include a workspace for various wellness professionals and others to share one or more ideas revolving around sharing stories. For example, a professional may share an article on how sharing stories can expedite the recovery of trauma. As another example, another professional may share an article on how storytelling can be a form of self-care and help with regulating one's emotions.

In some embodiments, the engagement marketplace 465 can include using tokens that are based on a distributed ledger technology (e.g., blockchain). In some embodiments, the users can use tokens to purchase products (e.g., drugs, books, etc.) and/or services (e.g., counseling sessions, etc.) from affiliate partners (e.g., vendors, pharmacies, etc.). In some embodiments, the engagement marketplace 465 can provide incentives to the users such that when the user purchases the products and/or services, the user is provided with rewards.

In some embodiments, the engagement subsystem 451 can include one or more software modules that are responsible for managing the Lotic Pod 455, the Stories Lab 460, and the engagement market place 465.

Referring to FIG. 4B, a block diagram of an architecture 480 is shown, in accordance with some embodiments. The exemplary architecture 480 of FIG. 4B includes the Lotic Platform 482 comprising the Lotic Insights API 484 in communication with both the Wisdom Engine 471 and the Lotic Core API 440. As shown in FIG. 4B, the Lotic Platform 482 supports a plurality of applications, including by way of non-limiting examples, the Lotic Pod 455, a SMS/MMS channel 486, as well as applications utilizing a front-end UI Library 488, such as Lotic Threads 415, Talk2Me 405, and Lotic Labs 410.

### Distributed Ledger Technology

A distributed ledger network (e.g., blockchain) may comprise a growing list of records, such as blocks, that may be linked and secured using cryptography. The database network system may be a distributed database system which may be collectively maintained by a plurality of nodes in a decentralized manner. The network may comprise a series of blocks that may be generated by, or with aid of, cryptography. The database network system may comprise or be an immutable digital public ledger. The database network system may be a continuously growing, distributed database. The distributed database may be cryptographically secured using the methods, procedures, and measures provided herein.

A blockchain may comprise one or more blocks. The one or more blocks may be associated with a sequence. Each block may contain a hash value of a previous block, a timestamp, and data (e.g., transaction data). The blockchain may be formed starting from a genesis block to a current block. The blocks may be generated in a chronological order, such that a hash value of the previous block may be known. In some cases, the blocks may be generated in a linear, chronological order. In some cases, blocks may be generated in a non-linear order or according to other patterns. The database network system may have substantially complete information from the genesis block to the most recently completed block.

In some cases, the database network system may store information comprising data in uniform-sized blocks. Each block may comprise hashed information from the previous block to provide cryptographic security. This may also be referred to as data hashing. Data hashing may comprise a hashing function. The hashed data and/or information may comprise the data and digital signatures, and/or keys (such as public key and/or private key) from the previous block, and the hashed information of the previous blocks that may go all the way back to the genesis block. The information may be distributed through a hash function that may then point to the address of the previous block. In some cases, the database network system may comprise a linked list that may comprise pointers. Blocks may store information validated by nodes that may be cryptographically secured according to the methods described herein.

The genesis block may be where the very first data in the network was generated. In some examples, the database network system may be a system of decentralized transactions and/or a system of decentralized trustless transactions. In some cases, the database network system may be a decentralized public ledger. For example, the database network system may stand as a trustless proof mechanism of all activities (such as transactions) on the network. Users may trust the system of the public ledger stored on many different decentralized nodes, in some cases worldwide, as opposed to establishing and maintaining trust with a counterparty, such as a transaction counterparty, such as another person, or a third-party intermediary (e.g., a bank).

The database network system may perform as another application layer to run on an existing stack of Internet protocols, adding a new tier to the Internet to enable activities such as performing economic transactions, currency payments such as digital currency payments, registering and maintaining financial contracts, transacting hard and/or soft assets, and more activities.

Further, the database network system may be used for activities beyond transactions, such as a registry and/or inventory system for recording, tracking, monitoring, and/or transacting of all assets. In some examples, the database network system may be like a ledger for registering assets, and/or an accounting system for transacting them on a global scale that can comprise all forms of assets held by parties worldwide. The database network system may be used for any form of asset registry, inventory, and exchange, comprising every area of finance, economics, money, hard assets (e.g., physical properties), intangible assets such as votes, ideas, reputation, intention, health data, personal data, media, and more.

In some cases, the database network system may be resistant to modification of data, or be immutable. The database network system may be an open and distributed ledger that can record transactions between two or more parties efficiently and in a verifiable way. Transactions may be recorded permanently. A blockchain may be managed by a network collectively adhering to a protocol (such as an algorithm) for inter-node communication and validation of new blocks. In some cases, once the data is recorded, the data in a given block cannot be altered retroactively without alteration of all subsequent blocks. Designs may be optimized such that they facilitate robust workflows where participants' uncertainty regarding data security may be marginal. The use of the database network system may remove the characteristic of infinite reproducibility from a digital asset. In some cases, it may confirm that each unit of value was transferred only once, solving the double-spending problem. For example, the transactions may be non-recursive and may not be prone to be repeated once validated in a block. The database network system may comprise a value exchange protocol. The database network system may be capable of maintaining title rights, such that when properly set up to detail the exchange agreement, it may provide a record that compels offer and acceptance.

In some examples, the database network system may be public. Participants may be allowed to verify and audit transactions independently and relatively inexpensively. The database network system may be managed autonomously using a network and a distributed timestamping server. They may be authenticated by mass collaboration powered by collective self-interest.

Blocks may hold batches of valid transactions that may be hashed and encoded into a structure. Each block may include the cryptographic hash of the prior block in the database network system, which may link them. This process may be performed iteratively (e.g., repetitively, redundantly). The iterative process may confirm the integrity of the previous block, all the way back to the genesis block.

In some cases, separate blocks may be produced concurrently, creating a temporary fork. In addition to a secure hash-based history, the database network system may have a specified algorithm for scoring different versions of the history so that one with a higher score can be selected over others. Blocks not selected for inclusion in the chain may be called orphan blocks.

The database network system may comprise a plurality of nodes. A node may be an entity, such as a machine (e.g., computer or another processing device), which is connected to the blockchain network. A machine may be controlled by a user. A machine may be controlled by another machine. A node may comprise a computer system described elsewhere herein. Each node may be capable of performing or configured to perform the task of validating and relaying transactions in the network. In some instances, each node may have a copy of the network system, which in some cases, may be downloaded once a user joins the network. In some cases, the download may be automatic.

The database network system may facilitate decentralized data distribution. Data may be stored across the entire network. By storing data across the entire network, the database network system may help decrease a number of risks that may otherwise be associated with data being held centrally, such as in an example centralized network. In some cases, the decentralized database network system may use ad-hoc message passing and/or distributed networking. The database network system may lack centralized points of vulnerability that malicious third parties can exploit; likewise, in some cases, there may be no central point of failure. In some cases, the database network system may be more secure against vulnerabilities and external attacks compared to a centralized network. In some cases, the database network system provided herein may be more secure against external attacks compared to other decentralized networks such as other blockchain networks.

In some embodiments, the tokens may be issued (or minted) and burned (or redeemed) within the engagement marketplace 465 that utilizes the distributed technology network. The minting of the tokens may be tied to a user providing a story to the insight engine 471, and the redemption of the token may be tied to the user using the token for a purchase.

In some embodiments, the tokens can include non-fungible tokens (NFTs). NFTs are generally created using the same type of tools generated for cryptocurrencies. NFTs can be built on a distributed ledger network, such as the one built for the engagement marketplace 465. An NFT is a unique identifier that cannot be copied, substituted, or subdivided, and are recorded on the blockchain in order to certify authenticity and ownership. The ownership of an NFT is recorded in the blockchain and can be transferred by the owner, allowing NFTs to be sold and traded. NFTs typically include references to digital files such as photos, videos, and audio. Because NFTs are uniquely identifiable assets, they differ from cryptocurrencies, which are fungible.

In some embodiments, the stories that are recorded by the user can be encoded as an NFT. In some embodiments, the tokens that are generated for the engagement marketplace 465 can be redeemed for items that include NFTs.

### Machine Learning Models

In some embodiments, the insight engine 471 can be used to support the well-being of its users. The insight engine 471 can be deployed on the computer system described in FIGS. 1-3. In some embodiments, the insight engine 471 can be deployed to derive one or more insights regarding the user based on one or more stories that the user records. Generally, the insight engine 471 can deploy one or more machine learning models that can receive as input text of the stories and then predict insights for the user. In some embodiments, the insight engine 471 can use the one or more derived insights and generate one or more recommended next actions for the user.

In some embodiments, the insight engine 471 can be used to support the well-being of a group and/or population of users. In further embodiments, the methods described herein may include a step of identifying or defining a group or population. In some cases, groups or populations are identified or defined manually. In other cases, groups or populations are identified or defined automatically by one or more of the processes and/or models described herein.

Groups or populations include, by way of non-limiting examples, members of an organization (such as a team, company, school, college, or university), individuals involved in a conflict, individuals involved in a natural disaster, individuals occupying, from, or passing through a geographic region, and other similar groupings of persons. In some cases, a group or population may be defined by factors affecting well-being of the members that are shared by, in common to, or similar among, the members of the group or population. In some embodiments, the insight engine 471 can be deployed to derive one or more insights regarding the group and/or population of users based on one or more combined stories that the users of the group and/or population record.

In some embodiments, the methods described herein may comprise a step of determining or authoring one or more prompts for a group or population. In some cases, prompts for a group or population are identified or authored manually. In other cases, prompts for a group or population are identified or defined automatically by one or more of the processes and/or models described herein. In some embodiments, groups or populations are organized, prompts for groups or populations are coordinated, and/or stories from groups or populations are identified by providing an identifier, such as a URL, QR code, or the like, to members of the group.

Generally, the insight engine 471 can deploy one or more machine learning models that can receive as input text of the stories, combine the stories, and then predict insights for the group and/or population. In further embodiments, stories are combined by using statistical or probabilistic techniques. For example, in some cases, elements are identified in story media and each element is weighted based on, by way of examples, how often in a story it is used, when in a story it is used, in what context in a story it is used, and in how many stories it is used. In various embodiments, group- and/or population-level insights include, by way of non-limiting examples, shared sentiments, commonalities, degree of sense of belonging, identification of rifts, schisms, and/or sub-groups, use of resources, and the like. In some embodiments, the insight engine 471 can use the one or more derived insights and generate one or more recommended next actions for the group and/or population. In some embodiments, the insight engine 471 can deploy one or more machine learning models to generate the one or more insights and/or the one or more recommended next actions.

In cases where insights and recommendations are generated for, and provided to, an individual (or their healthcare provider) based on stories they have shared, privacy and data security such as data encryption are, or course, important. In cases where insights and recommendations are generated for a group or population, based on collective stories, in some embodiments, further enhanced privacy and data security features are utilized, because the insights and recommendations may be provided to others not in the group or population or not contributing stories of their own. In further embodiments, the purpose of such enhanced privacy and data security features may be to prevent data from being traced back to any particular individual in the group or population. In some embodiments, proper nouns are identified and stripped out or replaced to anonymize persons, places, and identifiable things in text generated from shared story media. In some embodiments, after translation and transcription, audio and/or video media files, which may be personally identifiable, are securely deleted.

In some embodiments, a first machine learning model can include an unstructured machine learning model that can be used to generate and/or derive the one or more insights about the user. The first machine learning model can be trained based on a training dataset that is generated by past users and/or the user currently using the insight engine 471. The training dataset for the first machine learning model can include sensor data generated from the wearable devices, stories that were recorded by users, reviews that were generated by the users based on their thoughts on various topics, answers to questions that the user provided in response to questions, and/or indications (e.g., check-ins) that the users provided of whether the users participated in one or more activities that were provided as a recommended next action.

In some embodiments, a training dataset for the one or more models may be initially created based on user recordings of one or more stories (or user-generated narratives). In some embodiments, the audio (or the audio of the video) can be transcribed, and unstructured text in the transcription can be placed into a semi-structured format via help of the prompts used to guide the user in telling each story. In some embodiments, the dataset can also be augmented to using, for example, sentence paraphrasing and existing open source models such as the Bidirectional Encoder Representations from Transformers (BERT) model.

In some embodiments, the transcribed text may be translated into a different language. For example, when the received story is in Polish, the story may be transcribed into Polish first, and then translated into English, before the text is run through an algorithm.

In some embodiments, the dataset can be labeled with one or more preset intent/topic labels by an intent classification model. For example, an intent/topic label of “messy_workspace” may be generated by a prompt and answer as follows. The prompt may be “Describe your current workspace. How often do you organize your desk?” and the answer may include “Well, I'll avoid the feeling I have right now of turning the camera around and showing what a disarray my desk is, but it is not important to me to have everything in its place.” Such intent/topic labels can be generated for a variety of topics that include emotions, goals, expectations, past traumas, qualities/traits, etc.

In some embodiments, the prompts may be tailored to specific situations. In some embodiments, if it is known that the user experienced a specific situation, the prompt may be tailored to the specific situation. In some embodiments, the user may be asked to provide information about certain aspects and/or events in their lives that can inform the insights engine 471 to generate one or more prompts that are tailored to the specific situation. For example, if the user indicates that the user fled a war in their own country, the insights engine 471 may generate a prompt that prompts the user to provide a story about the war, about how they fled, about the people they fled with, etc.

In some embodiments, active learning may occur based of feedback related to the predicted labels for fine-tuning and/or updating the intent classification model. In some embodiments, the learning can entail invoking sentence encoders to determine statistically significant portions of a sentence for generating the intent labels. In some embodiments, a logistic regression may also be used to learn and fine-tune relationships between sentences in the stories with intent labels.

In some embodiments, a training dataset may be used to initially to train the intent classification model to generate intent labels for the dataset. The training dataset may include stories along with intent labels. The training dataset may also include augmented data and a library of sentences that have been gathered by scraping third-party forums. The training can invoke logistic regression and also leverage existing machine learning techniques, such as BERT, for training the intent classification model. In some embodiments, the model may be evaluated and adjusted as necessary based on learning.

In some embodiments, the insight engine 471 can run a sentiment analysis algorithm (e.g., RoBERTa) to extract one or more sentiments/emotions and/or opinions of the user attached to the topic associated with the story. The one or more sentiments/emotions and/or opinions can include a personality metric, a personal theme, a speech pattern, a stress metric, a user motivation, and/or an emotional well-being metric. The output of the sentiment analysis algorithm can include a sentiment polarity score on a scale of −1 for negative to +1 for positive.

In some embodiments, a machine learning model can be deployed to generate a summary of the story.

In some embodiments, the user can wear one or more devices that can generate sensor data. The sensor data can be generated from any device that includes a sensor on the user and/or near the user. For example, the sensor data can include data generated from a wearable device that can detect heart rates, exercise metrics, oxygen levels, sleep patterns, activity data, etc.

In some embodiments, the intent labels output by the intent classification model, sentiment polarity scores from sentiment analysis, and Likert scores can be used to compute wellness dimension scores for the dimension to which the story relates.

In some embodiments, wellness dimension scores may be used to compute personality insights (or insights) in the form of personality scores. In some embodiments, one or more of the wellness dimension scores can be used to compute the one or more insights. In some embodiments, the insights can include sentiment, intent, patterns, beliefs, and motivations of the user whose stories were analyzed.

In some embodiments, the sentiment analysis is performed for a group of people, or a population, instead of one individual. In some embodiments, the group of people have gone through a similar experience. For example, the group of people may have experienced a war, an earthquake, a fire, a tsunami, a natural disaster, etc. In some embodiments, all of the narratives of the group of people can be compiled, or combined, into one narrative and analyzed together as one narrative. Then group insights and group recommended next actions can be derived that can be generally applied to the group of people.

In some embodiments, a second machine learning model can include a structured machine learning model that can be used to generate one or more recommended next actions. For example, the user can be provided a recommendation to go for a walk, take a vacation, read a book, talk to a wellness professional, etc. The second machine learning model can generate one or more recommended next actions based on the user's input and/or stories that were used in the first machine learning model and/or the one or more insights generated from the first machine learning model.

In some embodiments, the insights may be provided to the user, and next actions relating to skills, tools, and content, may be recommended to the user based on such insights. In some embodiments, a supervised learning model can be used to receive the insights as input and output one or more recommended next actions.

Because well-being, the factors that can affect well-being, and other conditions change over time, in some embodiments, analyses described herein are performed more than once, on an ad hoc basis, and/or periodically (e.g., daily, weekly, monthly, etc.) to generate time-series data. In further embodiments, the time-series data may be stored in a time-series database (TSDB), such as, by way of examples, MongoDB, Prometheus, Amazon Timestream, Apache Druid, and the like. In some embodiments, the time-series data may be used to calculate a change or difference in sentiment, intent, well-being, insights, and the like, over time. In some embodiments, the time-series data is used to conduct benchmarking of measures of sentiment, intent, well-being, insights, and the like, against historical datasets.

### Large Language Models

In some embodiments a large language model (LLM) may be deployed. An LLM is a type of machine learning model that can perform a variety of natural language processing (NLP) tasks such as generating and classifying text, answering questions in a conversational manner, and translating the text from one language to another. LLMs are trained with immense amounts of data and use self-supervised learning to predict the next token in a sentence, given the surrounding context. The process is repeated until the model reaches an acceptable level of accuracy. LLMs may be pretrained on a large, general-purpose dataset. Once the LLM is pre-trained for high-level features, the model can be fine-tuned for specific tasks.

An LLM may be deployed for the insight engine. Once the LLM is pre-trained on the large dataset, the LLM may be fine-tuned with data of the user that has been acquired based on previous interactions with the insight engine. For example, the data for the fine-tuning may be based on previously recorded stories that the user has provided and/or insights that were generated based on those stores.

Once the LLM is trained and fine-tuned for the insight engine, the LLM may be deployed to generate prompts for the user. For example, there may be a script that asks the question “What should I ask the user to describe?” or something similar, and the LLM may provide a prompt that can then be asked the user. Then once the prompt is provided to the user, the user may respond by providing the story that is a response to the prompt. The recorded story may then be used for analysis and derivation of insights by the insight engine. The story may also be used as additional training data for additional fine-tuning.

### Insights Platform (or Insight Engine)

In some embodiments, an insights platform can be used to record and analyze stories by the user to derive or generate insights regarding the user. For example, a user application for the insights platform can include a software application that can be installed on an electronic device such as a mobile device, computer, tablet, wearable device, smart glasses, etc. The user application can include a recording tool that a user may access to record audio and/or video disclosures about a topic. The recording can be made in response to a prompt provided by the user application or unprompted (e.g., free response, free form, etc.). In some embodiments, the recording can be saved locally to the device on which the user application is running. In some embodiments, the recording can be streamed to a remote server that can save the recording. In some embodiments, the recording can have any length of time. In some embodiments, the recording may be made first through a wearable device and then transmitted to the device on which the user application is running.

In some embodiments, the recording can be transmitted to a server that can analyze the recording. In some embodiments, the recording can be automatically transcribed into text. In some embodiments, the text can be analyzed by one or more machine learning models to provide one or more insights into the user.

In some embodiments, the pairing devices can generally include custom hardware devices that can pin to the user's clothes. The pairing devices can assist the user in recording the stories that the user shares. An example of the pairing device may include the wearable device.

### System for Recording Stories

FIG. 4C shows a schematic overview of a system 490 for recording stories using a wearable device, in accordance with some embodiments. The system 490 may include the wearable device 491, the mobile device 492, and one or more well-being servers (or processors) 493.

In some embodiments, the wearable device 491 can include a handheld device that a user can hold in their hand. In some embodiments, the wearable device further comprises an attachment mechanism configured to attach or couple the wearable device to the user or a clothing or a keychain or other device held by the user. In some embodiments, the attachment mechanism comprises one of a pin, a clip, or a keychain. In some embodiments, the attachment mechanism can enable the user to attach the device to a necklace, a bracelet, or other piece of accessory. Further, the attachment mechanism can attach to a lapel or the inside of a piece of clothing. In some embodiments, the wearable device can be visible from the outside or hidden in the inside of the clothing such that others cannot see the wearable device.

In some embodiments, the mobile device 492 can include one of a cell phone, laptop computer, a tablet, and the like. The mobile device 492 can be connected to the wearable device 491 via, e.g., a Bluetooth or Bluetooth Low Energy (BLE) connection but embodiments are not limited thereto. For example, the wearable device 491 can be connected to the mobile device via Wi-Fi, the Internet, near-field communication (NFC), and any other communication protocol or system as described herein.

In some embodiments, the user application for the well-being platform can be installed on the mobile device 492. In some embodiments, the stories that are recorded via the wearable device 491 can be transferred to the user application installed on the mobile device 492. The mobile device 492 can be used to control the wearable device 491. For example, the mobile device 492 can, via the user application installed on the mobile device 492, provide instructions or commands to the wearable device 491 to turn on/off the wearable device 491, record stories via the microphone in the wearable device 491, erase the stories on the wearable device 491.

In some embodiments, the one or more well-being servers 493 can store the stories that are received from the mobile device 492. The one or more well-being servers 493 can be connected to the mobile device 492 via any wireless or wired means of communication. The one or more wellbeing servers 493 can receive the stories in audio files and analyze them to generate insights. The insights can then be provided back to the mobile device 492 so that the user can access them.

### Wearable Device

FIG. 4D shows a non-limiting example of a schematic overview of the wearable device 491 of FIG. 4C, in accordance with some embodiments. The wearable device 491 may include one or more components include a memory 505, a processor 510, one or more push buttons (PBs) 521, 522, 523, a microphone 530, a vibration module 540, one or more light-emitting diodes (LEDs) 551, 552, 553, transmitter (Tx)/receiver (Rx) module 560, a speaker 570, and/or one or more peripherals 580. Although certain components are shown in FIG. 4D, and in some instance certain number of those components are shown (e.g., three (3) PBs 521-523, three (3) LEDs 551-553), however embodiments are not limited thereto. Although not shown, there may be other features and functions that are included in the wearable device. For example, an on-off switch may be incorporated into the housing of the wearable device to switch the wearable device on and off.

In some embodiments, disclosed is a wearable device for recording a story from a user, comprising: a microphone (e.g., microphone 530) configured to receive the story in an audio file; a storage medium (e.g., memory 510) configured to temporarily store the audio file; a transmitter (e.g., Tx/Rx module 560) configured to transmit the audio file to an external device; and a controller (or processor 505) configured to automatically erase the audio file from the storage medium after the audio file has been transmitted to the external device if the user has opted-in to automatic deletion.

In some embodiments, the controller may cap the length of each story to about 3 minutes long, but embodiments are not limited thereto. In some embodiments, the story may be longer or shorter depending on embodiments.

In some embodiments, the controller may be connected to the other components of the wearable device. For example, the controller may be connected to the memory, microphone, push buttons, peripherals, Tx/Rx module, speaker, vibration module, and LEDs. In some embodiments, all data received and transmitted may transferred to or from the processor.

In some embodiments, the memory may include a temporary storage for storing the stories that are recorded. In some embodiments, the processor may be configured to automatically erase the stories in the memory once the story has been transferred to the mobile device. In some embodiments, the memory may store other information such as metadata about the stories including an identifier for each story that was recorded in the memory, when and where the story was recorded, how long the recording is, etc. In some embodiments, the memory may store operational data of the wearable device including how long the wearable device has been used, how long it has been since the last story finished recording, how much battery power has been used or is remaining, etc.

In some embodiments, the wearable device further comprises one or more push buttons (e.g., PBs 521-523) electrically connected to the controller. In some embodiments, the push buttons may be used to control the wearable device. For example, the user may press one or more of the push buttons to wake up the wearable device from sleep mode, transfer the files in the memory to the mobile device, etc. In some embodiments, the one or more push buttons includes a first button to initiate the recording and/or end the recording. In some embodiments, the one or more push buttons includes a second button to reset the wearable device. In some embodiments, one of the one or more push buttons is configured to enable the wearable device to enter a Bluetooth pairing mode to initialize connection to a platform on or connected to the external device.

In some embodiments, each of the push buttons may include different functions. For example, a first push button may correspond to a “record” function such that when pressed, the wearable device will enter into record mode to begin recording the audio from the user. As another example, a second push button may correspond to a “connect” function such that when pressed, the wearable device will enter into pairing mode to pair the wearable device with the mobile device. The user may then establish a Bluetooth/BLE connection with the wearable device using the mobile device. In some embodiments, a third push button may correspond to an “erase” function” such that when pressed, the wearable device will enter into erase mode to erase the latest and/or all of the recordings that are saved on the memory.

In some embodiments, the microphone may be used to receive or pick up the audio signal from the user and convert the sounds into an electrical signal. The microphone may have a small form factor and be built within the housing of the wearable device such that the microphone does not protrude from the housing.

In some embodiments, the one or more components comprises a buzzer (e.g., vibration module 540) configured to buzz or vibrate to provide the cue. In some embodiments, the vibration module may allow the wearable device to vibrate or buzz to inform the user that something has happened and requires the user's attention.

In some embodiments, the one or more components comprises one or more LEDs (e.g., LEDs 551-553) configured to provide the cue as a particular pattern or color. In some embodiments, the LEDs may be used to also notify the user of the operational status of the wearable device. In some embodiments, different patterns may be used to notify the user of different things. For example, the LEDs may have a different pattern to notify that the battery is low on charge, the memory is almost full, whether the mobile device is detected, whether the connection with the mobile device has been made, and more. In some embodiments, the user may customize the different patterns for the LEDs.

In some embodiments, the Tx/Rx module may include a transceiver (e.g., transmitter and receiver device or module) and may be used to establish the Bluetooth connection with the mobile device 492. The Tx/Rx module may be used to send out the stories from the wearable device 491 as well as other signals regarding the wearable device 491 (e.g., signal indicating battery is low, signal indicating memory is almost full, etc.).

In some embodiments, the controller is configured to establish a connection to the external device via Bluetooth using the Tx/Rx module. In some embodiments, the wearable device is further configured to operate without the user accessing the external device after the connection is established.

In some embodiments, the one or more components comprises a speaker (e.g., speaker 570) configured to provide the prompt in audio format. In some embodiments, the speaker may be used to prompt the user. For example, the user application on the mobile device may indicate to the user to share a story about a particular topic. In this case, an audio prompt to the user may be shared via the speaker. In some embodiments, the speaker may be used to replay the stories that were recorded by the user and still saved in the memory.

In some embodiments, the cue may be provided as a tone or tune using the speakers. For example, the processor may generate a tone or tune that the user may recognizes as a cue to provide a story.

In some embodiments, the peripherals may include a universal serial bus (USB) interface, one or more slots for receiving memory devices (e.g., MicroSD card), an audio jack for external microphones to connect to the wearable device, a power jack for connecting a charger to charge the battery of the wearable device, etc.

### File Transfer and Erasure

In some embodiments, the audio files stored on the memory may be automatically transferred to the mobile device. In some embodiments, the transfer may occur whenever a recording has ended. In some embodiments, the transfer may occur when a certain number of recordings have been saved (e.g., after 5 recordings have been saved). In some embodiments, the transfer may occur when the wearable device is charging the battery of the wearable device.

In some embodiments, the transfer may not initiate if the wearable device is not connected to the mobile device. For example, if the wearable device is out of range for a Bluetooth connection from the mobile device, the transfer may not occur.

In some embodiments, when the audio file transfer from the memory of the wearable device to the mobile device (or user application of the mobile device) has initiated, the mobile device may validate the file transfer. In some embodiments, the controller is further configured to receive confirmation that the audio file has been validated. In some embodiments, the validation comprises successfully transferring to the mobile device and the story being accessible by a platform (e.g., the insights platform or insight engine) on or connected to the external device (e.g., mobile device 492). For example, if the validation is completed, the user may be able to access the story on the mobile device.

In some embodiments, the controller is further configured to automatically erase the audio file after the audio file has been validated if the user has opted-in to automatic deletion. In some embodiments, the controller is further configured to retain the audio file after the audio file has been validated if the user has not opted-in to automatic deletion. In some embodiments, the default option may be to automatically delete the audio file. In other embodiments, the default option may be to automatically retain the audio file. In some embodiments, the user may delete the audio file at a later time via their external device.

In some embodiments, the wearable device further comprises a one or more components configured to provide a cue. In some embodiments, the cue prompts the user to provide the story. In some embodiments, the cue prompts the user that a battery level of the wearable device is low. In some embodiments, the cue prompts the user that there is a predetermined amount of time remaining in the recording.

In some embodiments, the wearable device may provide warnings about the battery level when the battery level reaches one or more thresholds. In some embodiments, the wearable device may prevent the microphone from receiving an audio recording because the battery level is too low, and the recording may cut-off in the middle of the storytelling.

In some embodiments, the wearable device 491 can be a handheld voice recorder that will work in conjunction with the insights platform to deliver insights to the user without accessing their mobile device. In some embodiments, when prompted by the user through a button press, the wearable device 491 may record an audio file until the button is pressed again or once a 3-minute (or any other amount of time that is predetermined) upper limit has been reached. The wearable device will have the compatibility to store multiple audio files to onboard MicroSD storage. These audio files will then be transferred to the Lotic app through a Bluetooth Low Energy connection. The files will be validated and erased off the wearable device after transfer.

In some embodiments, the wearable device may include a microcontroller. In some embodiments, the microcontroller may be equivalent to the processor 505. In some embodiments, the microcontroller may be based on an nRF5340 microcontroller but embodiments are not limited thereto.

In some embodiments, the microphone may be connected via i²s to the microcontroller to obtain audio data for the recordings, but embodiments are not limited thereto, and a different protocol may be used to connect the microcontroller to the microphone. In some embodiments, the vibration module may include a piezoelectric buzzer as well as a vibration device are used to provide feedback to the user based on the operation of the wearable device. In some embodiments, three LEDs are provided for visual feedback based on if recording has started as well as charging parameters of the battery, but embodiments are not limited thereto and fewer or more LEDs may be used.

In some embodiments, five momentary push buttons may be used to function operate the wearable device, but embodiments are not limited thereto, and more or fewer push buttons may be used. In some embodiments, the push buttons may include record button to initiate and end recordings, a reset button for resetting the wearable device (e.g., restarting the processor, erasing the memory, etc.) and a general purpose input/output (GPIO) button for debugging purposes.

In some embodiments, the wearable device may include a rechargeable lithium polymer battery that can power the different electronic components.

Once the moments are transferred to the app, they will be identified with a unique tag to indicate they came from wearable device.

### Sensor Data

In some embodiments, the wearable device may include on or more sensors that can generate sensor data. For example, the sensor data can include data generated from a wearable device that can detect heart rates, exercise metrics, oxygen levels, sleep patterns, activity data, etc.

In some embodiments, the sensor data may be transmitted to the mobile device and the insight engine along with the stories for analysis. In some embodiments, the sensor data may be included in the training dataset for the machine learning model(s).

In some embodiments, an accelerometer may be used. The accelerometer may include 6 degrees of freedom. In some embodiments, the accelerometer may be used to track gestures of the user. In some embodiments, the accelerometer may include track movement of the device while the user is using the wearable device.

In some embodiments, the wearable device may include various security features to help protect the privacy of the user. For example, the user may not wish the private content from the stories be leaked to others. In some embodiments, the stories may be encrypted when the stories are processed and saved to the memory. In some embodiments, the stories may be remain encrypted until the stories are transferred to the mobile device or even the insights platform. In some embodiments, the mobile device or the insights platform may have a key to decrypt the encrypted stories.

In some embodiments, the wearable device may deploy secure deletion. For example, after the story has been transferred to the mobile device and the validation confirmation is received, the wearable device may overwrite the story with data. For example, the data used to overwrite the stories may be garbage or auto-generated that do not actually contain information.

In some embodiments, the stories may be automatically deleted even if the stories are not transferred to the mobile device or insights platform within a predetermined amount of time. For example, if the stories have been in the memory of the wearable device for 3 days (which may be longer than typical), and the stories have not been transferred out, the processor may automatically enable a process to erase the stories to protect the privacy of the user.

### Example Wearable Device Workflow

An example workflow of using the wearable device is described. One of ordinary skill will recognize that the example workflow described herein is merely for exemplary purposes, and embodiments are not limited thereto. Various modifications, including the addition and/or removal of one or more steps, may be made while still remaining within the scope of the inventive concept.

First, the wearable device may be in an idle state or idle mode when the wearable device has not been used or any of the push buttons have been used by a predetermined amount of time. For example, the predetermined amount of time may be about 30 seconds, but embodiments are not limited thereto can be longer or shorter.

The user may push a push button corresponding to the “record” function, which may bring the wearable device out of idle mode to active mode. After the wearable device enters active mode, if the microphone or processor receiving the microphone does not detect an audio signal (or the signal amounts to nothing more than noise based on various filtering) for the predetermined amount of time, the wearable device may re-enter idle mode until one or more push buttons are pressed again or the user activates the wearable device using the user application installed on the mobile device.

Then, the user may record their story using the wearable device by speaking into the microphone. The user may record up to a predetermined time limit, e.g., about 3 minutes, but embodiments are not limited thereto. In some embodiments, the predetermined time limit may be less than or more than 3 minutes. In some embodiments, the user's story may be streamed to the mobile device via the Bluetooth/BLE connection such that there may not be a predetermined limit, since the mobile device can continuously receive the story, and the mobile device can substantially simultaneously, or shortly thereafter, upload or stream the story to the insight engine for analysis.

In some embodiments, while the wearable device is in active mode, the wearable device may connect to or re-establish connection with the mobile device using Bluetooth or BLE. During this time, the wearable device may act as a Bluetooth/BLE server so that the data and files can be provided to the user application.

In some embodiments, once the recording has finished, an audio transcoder within the wearable device may process the audio recording so that the audio recording can be saved. In some embodiments, the audio file may be saved in the memory. The memory may include flash memory but embodiments are not limited thereto, and any suitable means of data storage may be deployed for the memory on the wearable device.

In some embodiments, the wearable device may be in transfer mode when the wearable device is ready to transfer files including the audio recording to the mobile device. The mobile device may have access to the memory on the wearable device via Bluetooth/BLE. In some embodiments, whether the story is uploaded (after the user finishes the recording) or streamed, one or more pieces of metadata may be provided with the audio file. For example, the metadata may include a file size, file count (since there may be multiple recordings), file states (e.g., the file type or quality), audio metadata (e.g., length of audio file, location where recorded, date and time of recording, etc.), audio file data (e.g., the audio file), battery level (e.g., how much battery the wearable device has remaining), unique tag/ID (e.g., a unique identifier number or ID that identifies the audio recording that was recorded and transferred), and/or pairing keys for the Bluetooth/BLE.

In some embodiments, once the files are transferred to the mobile application, validation of the files may be performed as discussed above. The validation process may include a determination of whether the file(s) have been properly stored in the memory of the mobile device and determination of whether there was any corruption in the transfer process. If a determination is made that the file(s) are valid, the file(s) and received data may be provided to the insight engine hosted on the well-being servers for processing and analysis.

In some embodiments, when the file(s) are transmitted to the mobile application, the mobile application may send the file(s) to the insight engine for analysis. In some embodiments, the mobile application may automatically upload the file(s) to the insight engine upon receipt. In some embodiments, the mobile application may upload the file(s) at a set time of day and/or when the mobile device is connected to high-speed Internet. In some embodiments, the file transfer from the wearable device to the mobile device and from the mobile device to the insight engine are performed using secure protocols.

In some embodiments, the user application (or the insight engine that is connected to the user application) may provide one or more sets of commands and/or data to the wearable device. For example, the user application may provide commands to set the date and time and to upgrade the firmware on the wearable device. In some embodiments, the user application may also transmit instructions to request information such as file info (e.g., metadata and other info), file count, file state, file data, battery info, and/or audio data (e.g., the audio recording). In some embodiments, the user application may provide instructions for the mobile application and/or the wearable device to perform certain actions such as encrypting the file(s), converting the file (e.g., WAV to MP3, etc.).

In some embodiments, as discussed above, the recordings may be transferred to the mobile device in batches. For example, the recordings may be transferred when the wearable device begins charging. As another example, the recordings may be set to transfer at a predetermined time of day or week. As another example, the recordings may be set to transfer when there is a set number of recordings (e.g., 10 recordings). As a further example, the recordings may transfer when the user initiates the transfer by pushing one or more push buttons on the wearable device and/or when the user initiates the transfer on the user application on the mobile device.

In some embodiments, after the audio recording has been saved in the memory, the wearable device may re-enter idle mode and repeat the process discussed above.

In some embodiments, the well-being servers may be remotely located from the mobile devices and accessible via a wireless connection. In some embodiments, as discussed above, the user application and/or the mobile device running the user application may receive the file size, file count, file state, audio metadata, audio file data, battery level, and unique tag/ID.

### Exemplary Embodiments

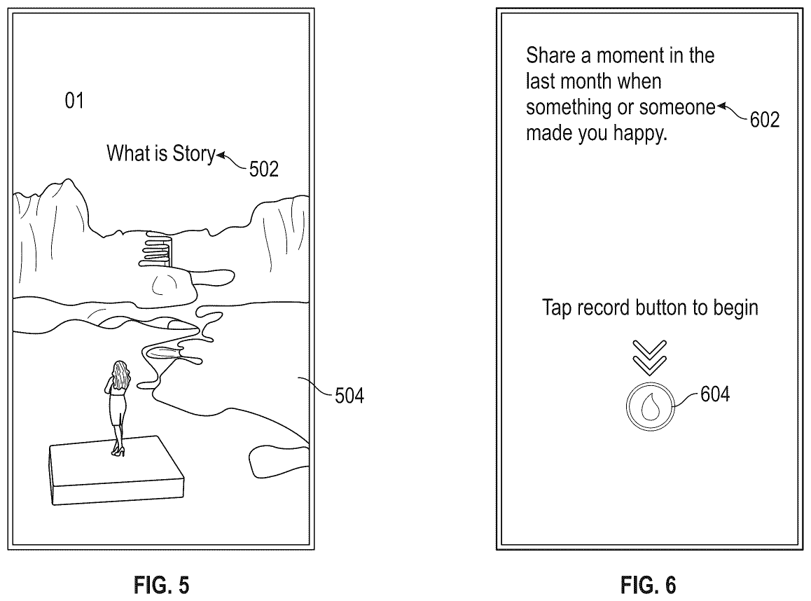

Referring to FIGS. 5-19, various non-limiting examples of GUIs for a recording studio module on the user application 405 allowing a user to record an unstructured user-generated narrative are shown. Although the examples shown in FIGS. 5-19 show how the user application 405 can be displayed in a cell phone, embodiments are not limited thereto, and the user application 405 can be launched on any electronic device, such as a tablet device, a laptop computer, a desktop computer, wearable device, etc. Furthermore, the text, font, colors, design, look and feel and other aspects of the examples shown in the GUI can vary, depending on embodiments.

FIG. 5 shows a non-limiting example of a GUI for a recording studio module allowing a user to record an unstructured user-generated narrative; in this case, a GUI displaying a first introduction page of a first topic of what a story is. The first introduction page may include a title text 502 that introduces the user to what the next one or more pages will be about. For example, the title text 502 can show “What is Story,” which can cue the user to describing what a “story” is and how to share the story to the user application 405. The introduction page may also include an image 504 that visually symbolizes and/or describes the title text 502. For example, in FIG. 5, the image 504 shows a person standing on a platform that is flowing through a stream, which can symbolize a person's experience in walking or flowing through a story. Such an image can help the user visualize and/or think of the story they want to convey. In some embodiments, the image 504 may include a video and/or multiple images.

FIG. 6 shows a non-limiting example of a GUI for a recording studio module allowing a user to record an unstructured user-generated narrative; in this case, a GUI displaying a prompt page for the first topic. Generally, the prompt page can prompt the user to share a story or a moment. The prompt page may include a prompt 602 that can ask the user to share a moment in the last month when the user was happy. The prompt page can also include a button 604 that the user can press to begin recording the audio and/or video of the user who can share the moment. The button 604 can be displayed in a first color or a first combination of colors. In some embodiments, the user may initiate the recording by tapping the button 604. In some embodiments, the user may record while pressing down the button 604. In some embodiments, the prompt page can also be designed to ask the user to provide any other input such as swiping, dragging, etc.

In some embodiments, the prompt 602 can be different so that the prompt 602 can invoke and/or trigger a different response from the user, while still allowing the user to share a story or moment related to a general topic. In some embodiments, the general topic may be high level thoughts or emotions that the user may have at the time of using the user application 405. For example, the prompt 602 may prompt the user to share something that made the user excited, that made the user sad, that made the user reflective, etc. One of ordinary skill will recognize that the prompts displayed on prompt 602 can vary widely, in accordance with embodiments. In some embodiments, the stories collected from responses may be collected and analyzed to obtain more accurate insights regarding the user.

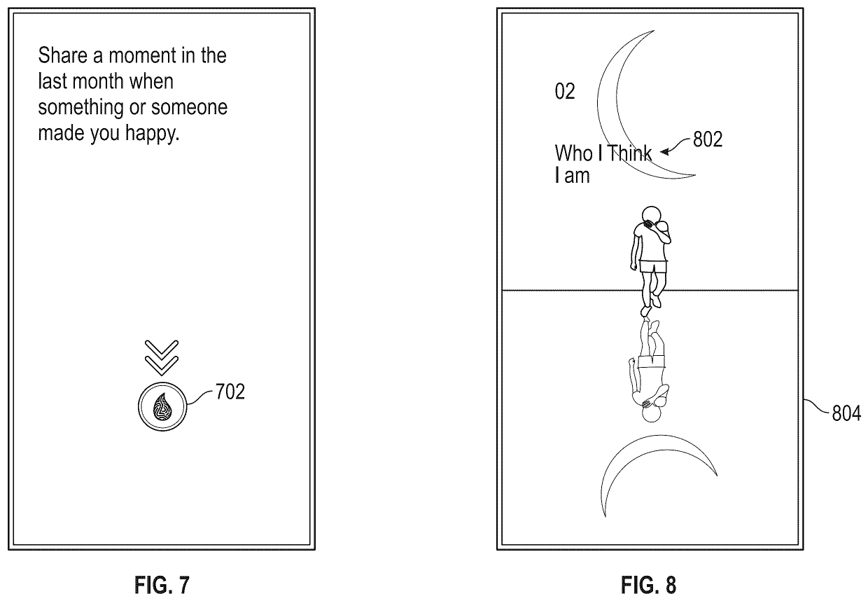

FIG. 7 shows a non-limiting example of a GUI for a recording studio module allowing a user to record an unstructured user-generated narrative; in this case, a GUI displaying a recording page for the first topic. The recording page can indicate to the user that user application 405 is recording the user's story or moment. The user can share their story and/or moment, by speaking, which is a response to the prompt 602. The recording page may include the prompt 602 that was displayed in the prompt page to remind the user what the user is sharing. The recording page may also indicate by the recording indicator 702 that the user application 405 is recording what the user is sharing. The recording indicator 702 may include a color different than the button 604 of FIG. 6. In some embodiments, the user application 405 may turn on the camera on the mobile device and display the user on the screen. In some embodiments, the user application 405 may record a video of the user sharing the story or moment. In some embodiments, the user application 405 may record the audio only. In some embodiments, the user may tap the recording indicator to stop the recording. In some embodiments, the user may tap the recording indicator again to continue recording. In some embodiments, when the user has completed the recording, the user may swipe up or sideways such that the user application 405 may display a new page.

In some embodiments, there may be multiple prompts and recordings for each topic. For example, the user may be prompted to share something that made the user happy in the last month and then the user may record the response. The user may then be prompted to share something that made the use sad in the last month and then the user may record the response. In some embodiments, the user application 405 may share the multiple prompts in sequence (e.g., one prompt per page) so that the user can focus on the given prompt when recording the user's response. The embodiments are not limited to how many prompts and recordings there are for each general topic.

FIG. 8 shows a non-limiting example of a GUI for a recording studio module allowing a user to record an unstructured user-generated narrative; in this case, a GUI displaying a second introduction page of a second topic of describing the user. The second introduction page may include a title text 802 that introduces the user to what the next one or more pages will be about. For example, the title text 802 can show “Who I think I am,” which can cue the user to describing oneself to the user application 405. The second introduction page may also include an image 804 that visually symbolizes and/or describes the title text 802. For example, in FIG. 8, the image 804 shows a person walking over a body of water with ripples coming from the place the person is, which can symbolize a person's own journey and how they became who they are at the time of sharing the recording. In some embodiments, the image 804 may include a video and/or multiple images.

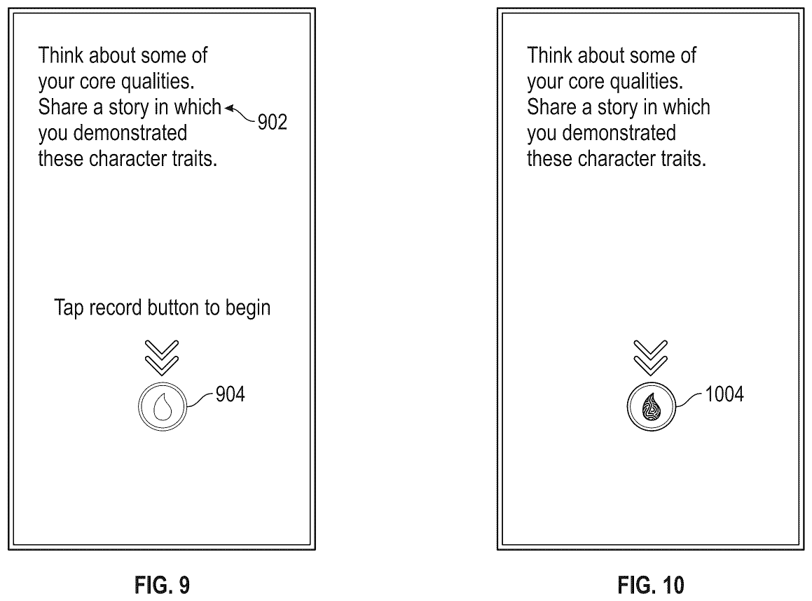

FIG. 9 shows a non-limiting example of a GUI for a recording studio module allowing a user to record an unstructured user-generated narrative; in this case, a GUI displaying a prompt page of the second topic. Generally, the prompt page can prompt the user to share a story or a moment. The prompt page may include a prompt 802 that can ask the user to think about some of the user's own core qualities and share a story that demonstrates these traits. The prompt page can also include a button 904 that the user can press to begin recording the audio and/or video of the user who can share the moment. The button 904 can be displayed in a first color or a first combination of colors. In some embodiments, the user may initiate the recording by tapping the button 904. In some embodiments, the user may record while pressing down the button 904. In some embodiments, the prompt page can also be designed to ask the user to provide any other input such as swiping, dragging, etc.

In some embodiments, the prompt 902 can be different so that the prompt 902 can invoke and/or trigger a different response from the user, while still allowing the user to share a story or moment related to a general topic. In some embodiments, the general topic may be general qualities and traits that the user has about oneself. For example, the prompt 902 may prompt the user to share a story that demonstrates traits about the user, a story that demonstrates the user's shortcomings, a story about what others have shared about the user, etc. One of ordinary skill will recognize that the prompts displayed on prompt 902 can vary widely, in accordance with embodiments. In some embodiments, the stories collected from responses may be collected and analyzed to obtain more accurate insights regarding the user.

FIG. 10 shows a non-limiting example of a GUI for a recording studio module allowing a user to record an unstructured user-generated narrative; in this case, a GUI displaying a recording page of the second topic. The recording page can indicate to the user that user application 405 is recording the user's story or moment. The user can share their story and/or moment, by speaking, which is a response to the prompt 902. The recording page may include the prompt 902 that was displayed in the prompt page to remind the user what the user is sharing. The recording page may also indicate by the recording indicator 1004 that the user application 405 is recording what the user is sharing. The recording indicator 1004 may include a color different than the button 904 of FIG. 9. In some embodiments, the user application 405 may tum on the camera on the mobile device and display the user on the screen. In some embodiments, the user application 405 may record a video of the user sharing the story or moment. In some embodiments, the user application 405 may record the audio only. In some embodiments, the user may tap the recording indicator to stop the recording. In some embodiments, the user may tap the recording indicator again to continue recording. In some embodiments, when the user has completed the recording, the user may swipe up or sideways such that the user application 405 may display a new page.

In some embodiments, there may be multiple prompts and recordings for each topic. For example, the user may be prompted to share a story about the user's qualities that make the user attractive to others and then the user may record the response. The user may then be prompted to share a story about the user's qualities that the user is working on and then the user may record the response. In some embodiments, the user application 405 may share the multiple prompts in sequence (e.g., one prompt per page) so that the user can focus on the given prompt when recording the user's response. The embodiments are not limited to how many prompts and recordings there are for each general topic.

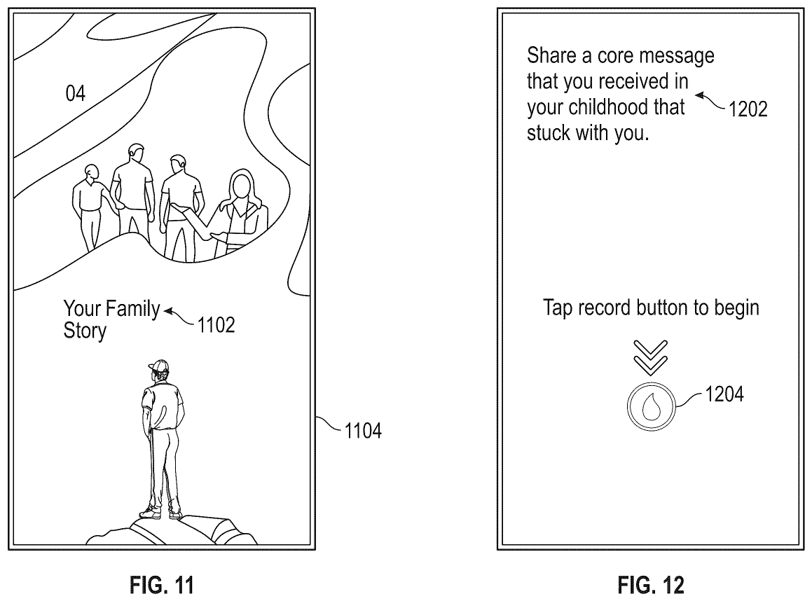

FIG. 11 shows a non-limiting example of a GUI for a recording studio module allowing a user to record an unstructured user-generated narrative; in this case, a GUI displaying a third introduction page of the third topic of describing the user's family. The third introduction page may include a title text 1102 that introduces the user to what the next one or more pages will be about. For example, the title text 1102 can show “Your Family Story,” which can cue the user to describing the user's family to the user application 405. The third introduction page may also include an image 1104 that visually symbolizes and/or describes the title text 1102. For example, in FIG. 11, the image 1104 shows a person standing on a hill and looking up to a silhouette of the person with several other people and everyone holding hands, which can symbolize a person's own family and how that family has impacted the person. In some embodiments, the image 1104 may include a video and/or multiple images.

FIG. 12 shows a non-limiting example of a GUI for a recording studio module allowing a user to record an unstructured user-generated narrative; in this case, a GUI displaying a prompt page of the third topic. Generally, the prompt page can prompt the user to share a story or a moment. The prompt page may include a prompt 1202 that can ask the user to share a core message that you received in the user's childhood that stuck with you. The prompt page can also include a button 1204 that the user can press to begin recording the audio and/or video of the user who can share the moment. The button 1204 can be displayed in a first color or a first combination of colors. In some embodiments, the user may initiate the recording by tapping the button 1204. In some embodiments, the user may record while pressing down the button 1204. In some embodiments, the prompt page can also be designed to ask the user to provide any other input such as swiping, dragging, etc.

In some embodiments, the prompt 1202 can be different so that the prompt 1202 can invoke and/or trigger a different response from the user, while still allowing the user to share a story or moment related to a general topic. In some embodiments, the general topic may be the user's childhood and upbringing. For example, the prompt 1202 may prompt the user to share a story about the user's siblings, about the user's parents, about the user's relatives, about a time that a sibling upset the user, about a time that the parent reprimanded the user, etc. One of ordinary skill will recognize that the prompts displayed on prompt 1102 can vary widely, in accordance with embodiments. In some embodiments, the stories collected from responses may be collected and analyzed to obtain more accurate insights regarding the user.

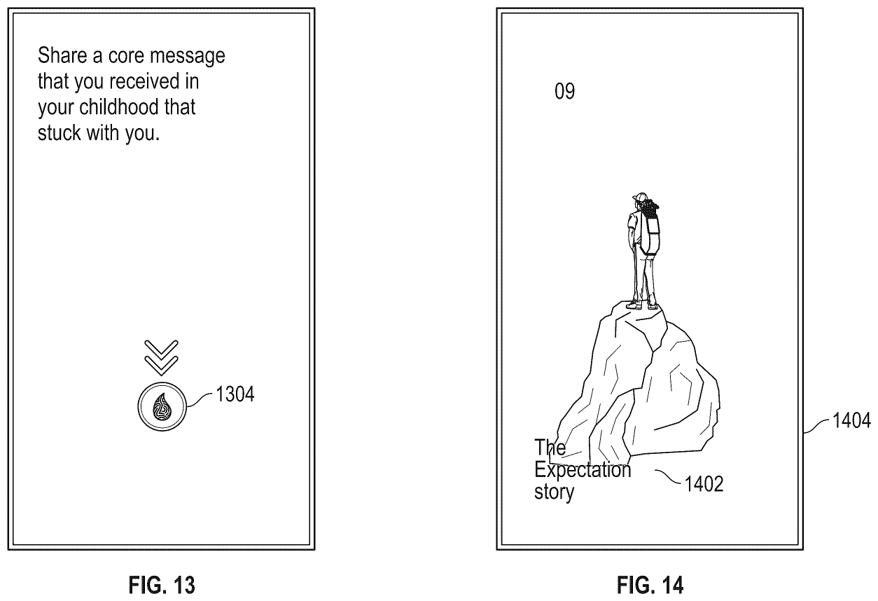

FIG. 13 shows a non-limiting example of a GUI for a recording studio module allowing a user to record an unstructured user-generated narrative; in this case, a GUI displaying a recording page of the third topic. The recording page can indicate to the user that user application 405 is recording the user's story or moment. The user can share their story and/or moment, by speaking, which is a response to the prompt 1202. The recording page may include the prompt 1302 that was displayed in the prompt page to remind the user what the user is sharing. The recording page may also indicate by the recording indicator 1304 that the user application 405 is recording what the user is sharing. The recording indicator 1304 may include a color different than the button 1204 of FIG. 12. In some embodiments, the user application 405 may tum on the camera on the mobile device and display the user on the screen. In some embodiments, the user application 405 may record a video of the user sharing the story or moment. In some embodiments, the user application 405 may record the audio only. In some embodiments, the user may tap the recording indicator to stop the recording. In some embodiments, the user may tap the recording indicator again to continue recording. In some embodiments, when the user has completed the recording, the user may swipe up or sideways such that the user application 405 may display a new page.

In some embodiments, there may be multiple prompts and recordings for each topic. For example, the user may be prompted to share a story about a time when the user's sibling made him happy and then the user may record the response. The user may then be prompted to share a story about a time when the user's family went on a memorable trip and then the user may record the response. In some embodiments, the user application 405 may share the multiple prompts in sequence (e.g., one prompt per page) so that the user can focus on the given prompt when recording the user's response. The embodiments are not limited to how many prompts and recordings there are for each general topic.

FIG. 14 shows a non-limiting example of a GUI for a recording studio module allowing a user to record an unstructured user-generated narrative; in this case, a GUI displaying a fourth introduction page of a fourth topic of describing the expectations. The fourth introduction page may include a title text 1402 that introduces the user to what the next one or more pages will be about. For example, the title text 1402 can show “The Expectation Story,” which can cue the user to describing the user's expectations in life to the user application 405. The fourth introduction page may also include an image 1404 that visually symbolizes and/or describes the title text 1402. For example, in FIG. 14, the image 1404 shows a person standing on a rock in a body of water and carrying a backpack, which can symbolize a person's own accomplishments in the past and other goals they hope to accomplish in the future. In some embodiments, the image 1404 may include a video and/or multiple images.

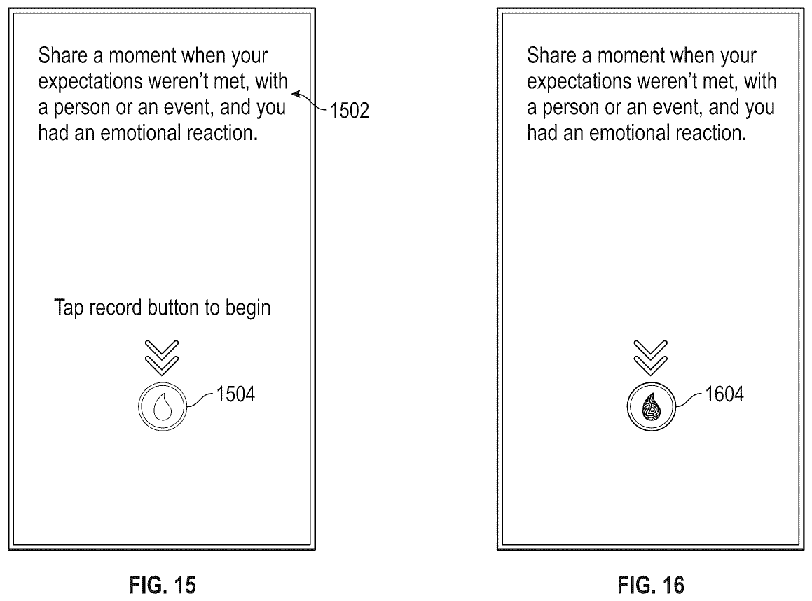

FIG. 15 shows a non-limiting example of a GUI for a recording studio module allowing a user to record an unstructured user-generated narrative; in this case, a GUI displaying a prompt page of the fourth topic. Generally, the prompt page can prompt the user to share a story or a moment. The prompt page may include a prompt 1502 that can ask the user to share a moment when the user's expectations were not met, with a person or an event, and the user had an emotional reaction. The prompt page can also include a button 1504 that the user can press to begin recording the audio and/or video of the user who can share the moment. The button 1504 can be displayed in a first color or a first combination of colors. In some embodiments, the user may initiate the recording by tapping the button 1504. In some embodiments, the user may record while pressing down the button 1504. In some embodiments, the prompt page can also be designed to ask the user to provide any other input such as swiping, dragging, etc.

In some embodiments, the prompt 1502 can be different so that the prompt 1502 can invoke and/or trigger a different response from the user, while still allowing the user to share a story or moment related to a general topic. In some embodiments, the general topic may be the user's expectations and goals. For example, the prompt 1502 may prompt the user to share a story about a time when the user was able to accomplish a goal, about a time the user failed at a task, about a time the user overcome an obstacle, etc. One of ordinary skill will recognize that the prompts displayed on prompt 1502 can vary widely, in accordance with embodiments. In some embodiments, the stories collected from responses may be collected and analyzed to obtain more accurate insights regarding the user.

FIG. 16 shows a non-limiting example of a GUI for a recording studio module allowing a user to record an unstructured user-generated narrative; in this case, a GUI displaying a recording page of the fourth topic. The recording page can indicate to the user that user application 405 is recording the user's story or moment. The user can share their story and/or moment, by speaking, which is a response to the prompt 1502. The recording page may include the prompt 1502 that was displayed in the prompt page to remind the user what the user is sharing. The recording page may also indicate by the recording indicator 1604 that the user application 405 is recording what the user is sharing. The recording indicator 1604 may include a color different than the button 1604 of FIG. 15. In some embodiments, the user application 405 may tum on the camera on the mobile device and display the user on the screen. In some embodiments, the user application 405 may record a video of the user sharing the story or moment. In some embodiments, the user application 405 may record the audio only. In some embodiments, the user may tap the recording indicator to stop the recording. In some embodiments, the user may tap the recording indicator again to continue recording. In some embodiments, when the user has completed the recording, the user may swipe up or sideways such that the user application 405 may display a new page.

In some embodiments, there may be multiple prompts and recordings for each topic. For example, the user may be prompted to share a story about a time when the user accomplished a goal and then the user may record the response. The user may then be prompted to share a story about a time when the user accomplished only a portion of the user's goals and then the user may record the response. In some embodiments, the user application 405 may share the multiple prompts in sequence (e.g., one prompt per page) so that the user can focus on the given prompt when recording the user's response. The embodiments are not limited to how many prompts and recordings there are for each general topic.

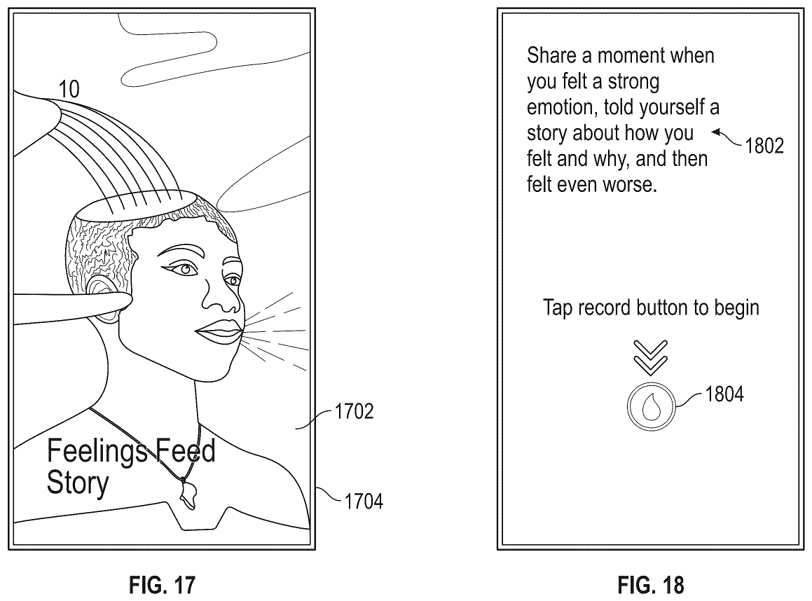

FIG. 17 shows a non-limiting example of a GUI for a recording studio module allowing a user to record an unstructured user-generated narrative; in this case, a GUI displaying a fifth introduction page of a fifth topic of describing the user's feelings. The fifth introduction page may include a title text 1702 that introduces the user to what the next one or more pages will be about. For example, the title text 1702 can show “Feelings Feed Story,” which can cue the user to describing the user's feelings to the user application 405. The fifth introduction page may also include an image 1704 that visually symbolizes and/or describes the title text 1702. For example, in FIG. 17, the image 1704 shows a person whose head is connected to a colorful rainbow and lines coming out of the mouth, which can symbolize a person's own varied feelings and emotions and the person verbalizing those feelings and emotions. In some embodiments, the image 1704 may include a video and/or multiple images.

FIG. 18 shows a non-limiting example of a GUI for a recording studio module allowing a user to record an unstructured user-generated narrative; in this case, a GUI displaying a prompt page of the fourth topic. Generally, the prompt page can prompt the user to share a story or a moment. The prompt page may include a prompt 1802 that can ask the user to share a moment when the user felt a strong emotion, told oneself a story about how the user felt and why, and then felt even worse. The prompt page can also include a button 1804 that the user can press to begin recording the audio and/or video of the user who can share the moment. The button 1804 can be displayed in a first color or a first combination of colors. In some embodiments, the user may initiate the recording by tapping the button 1804. In some embodiments, the user may record while pressing down the button 1804. In some embodiments, the prompt page can also be designed to ask the user to provide any other input such as swiping, dragging, etc.

In some embodiments, the prompt 1802 can be different so that the prompt 1802 can invoke and/or trigger a different response from the user, while still allowing the user to share a story or moment related to a general topic. In some embodiments, the general topic may be the user's feelings and emotions. For example, the prompt 1802 may prompt the user to share a story about a time when the user felt happy, about a time when the user felt hopeful, etc. One of ordinary skill will recognize that the prompts displayed on prompt 1802 can vary widely, in accordance with embodiments. In some embodiments, the stories collected from responses may be collected and analyzed to obtain more accurate insights regarding the user.

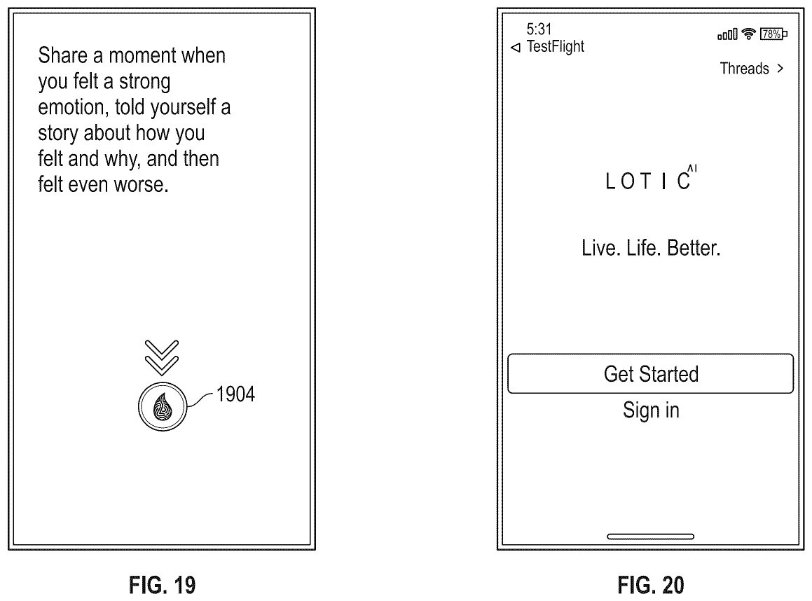

FIG. 19 shows a non-limiting example of a GUI for a recording studio module allowing a user to record an unstructured user-generated narrative; in this case, a GUI displaying a recording page of the fifth topic. The recording page can indicate to the user that user application 405 is recording the user's story or moment. The user can share their story and/or moment, by speaking, which is a response to the prompt 1802. The recording page may include the prompt 1802 that was displayed in the prompt page to remind the user what the user is sharing. The recording page may also indicate by the recording indicator 1904 that the user application 405 is recording what the user is sharing. The recording indicator 1904 may include a color different than the button 1804 of FIG. 18. In some embodiments, the user application 405 may tum on the camera on the mobile device and display the user on the screen. In some embodiments, the user application 405 may record a video of the user sharing the story or moment. In some embodiments, the user application 405 may record the audio only. In some embodiments, the user may tap the recording indicator to stop the recording. In some embodiments, the user may tap the recording indicator again to continue recording. In some embodiments, when the user has completed the recording, the user may swipe up or sideways such that the user application 405 may display a new page.

In some embodiments, there may be multiple prompts and recordings for each topic. For example, the user may be prompted to share a story about a time when the user was happy and then the user may record the response. The user may then be prompted to share a story about a time when the user was sad and then the user may record the response. In some embodiments, the user application 405 may share the multiple prompts in sequence (e.g., one prompt per page) so that the user can focus on the given prompt when recording the user's response. The embodiments are not limited to how many prompts and recordings there are for each general topic.

As described above, after the user provides one or more stories based on one or more prompts, the stories can be analyzed to generate one or more insights about the user. The analysis may include transcription of the stories, inputting the terms from the transcriptions into one or more machine learning models, and outputting the one or more insights from the models based on the models.

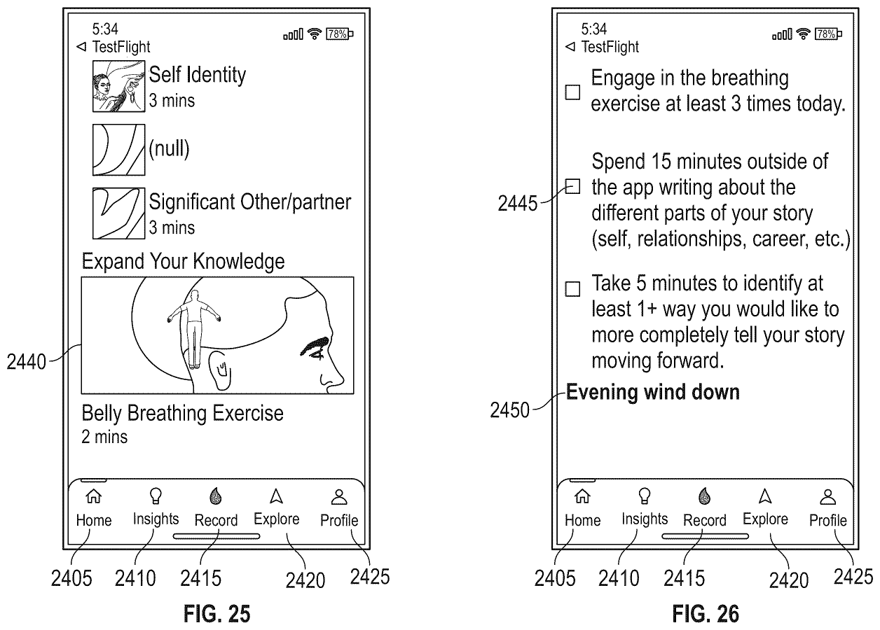

Referring to FIGS. 20-31, various non-limiting examples of GUis for a well-being application are shown. Although the examples shown in FIGS. 20-31 show how the application can be displayed on a mobile device, embodiments are not limited thereto, and the application can be deployed to any computing device, such as a tablet device, a laptop computer, a desktop computer, a wearable device, etc. Furthermore, the text, font, colors, design, look and feel, and other aspects of the examples shown in the GUI can vary, depending on embodiments.

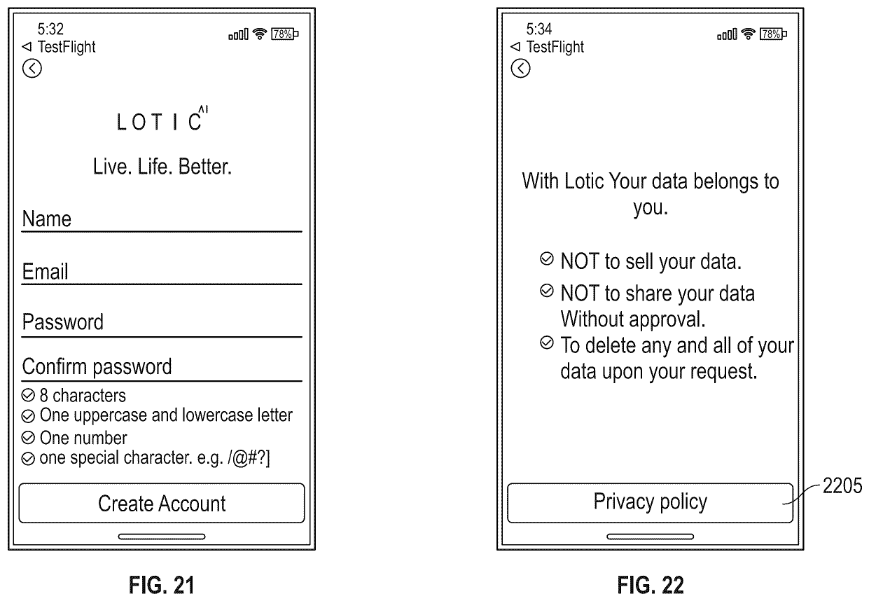

FIG. 20 shows a non-limiting example of a GUI for a well-being application; in this case, a GUI displaying a splash screen. The splash screen may include a “Get Started” button providing access to an account creation screen (see, e.g., FIG. 21) and a “Sign In” button.

FIG. 21 shows a non-limiting example of a GUI for a well-being application; in this case, a GUI displaying an account creation screen. The account creation screen may include entry fields for Name, Email, and Password, as well as a “Create Account” button.

FIG. 22 shows a non-limiting example of a GUI for a well-being application; in this case, a GUI displaying a data usage information screen providing access to a privacy policy. The data usage information screen may include information pertaining to sale and sharing of user data as well as information pertaining to deletion of user date, such as a Right To Be Forgotten (RTBF). The data usage information screen may also include a “Privacy Policy” button 2205 allowing a user to access a legal privacy policy document for the application.

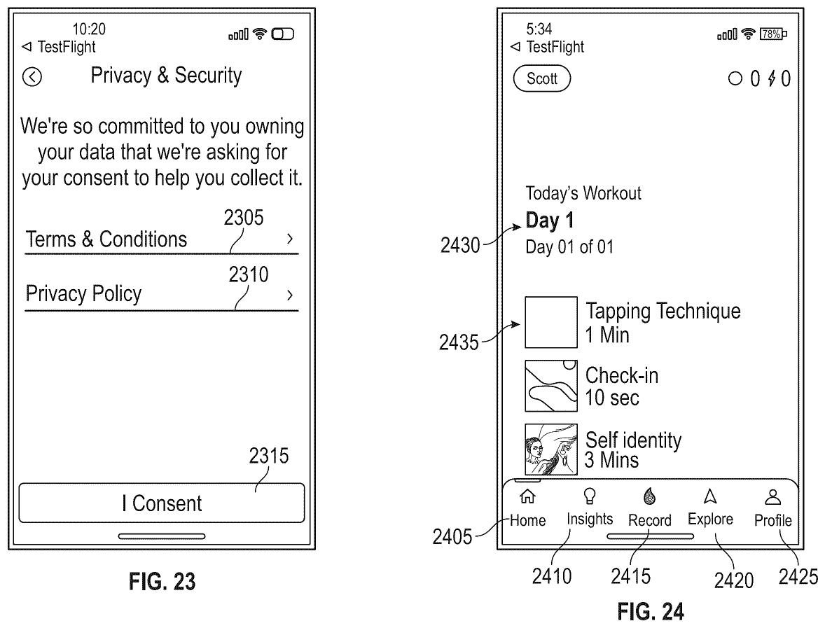

FIG. 23 shows a non-limiting example of a GUI for a well-being application; in this case, a GUI displaying a privacy and security consent screen providing access to terms & conditions and a privacy policy. The privacy and security consent screen may include links allowing a user to access legal terms & conditions 2305 and privacy policy 2310 documents as well as a “I Consent” button 2315 allowing a user to submit their acknowledgement and consent.

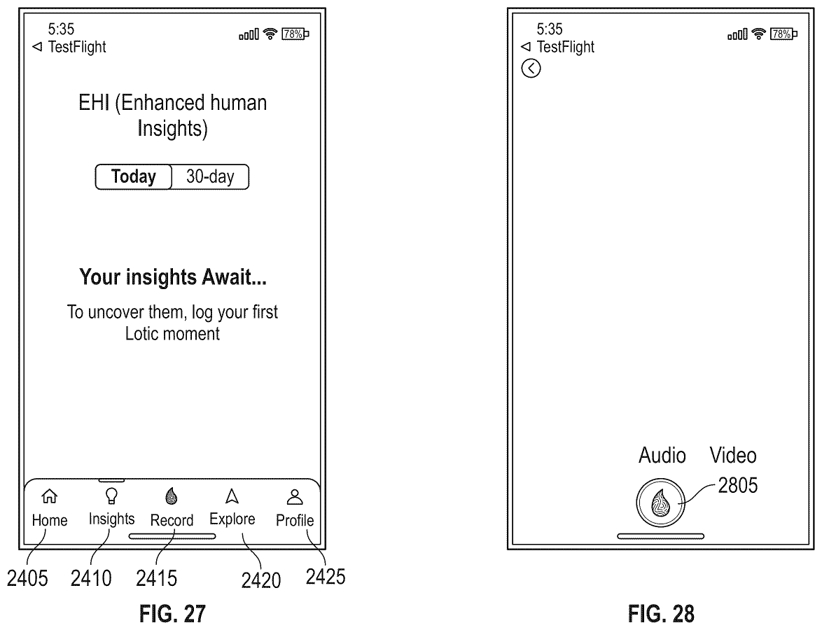

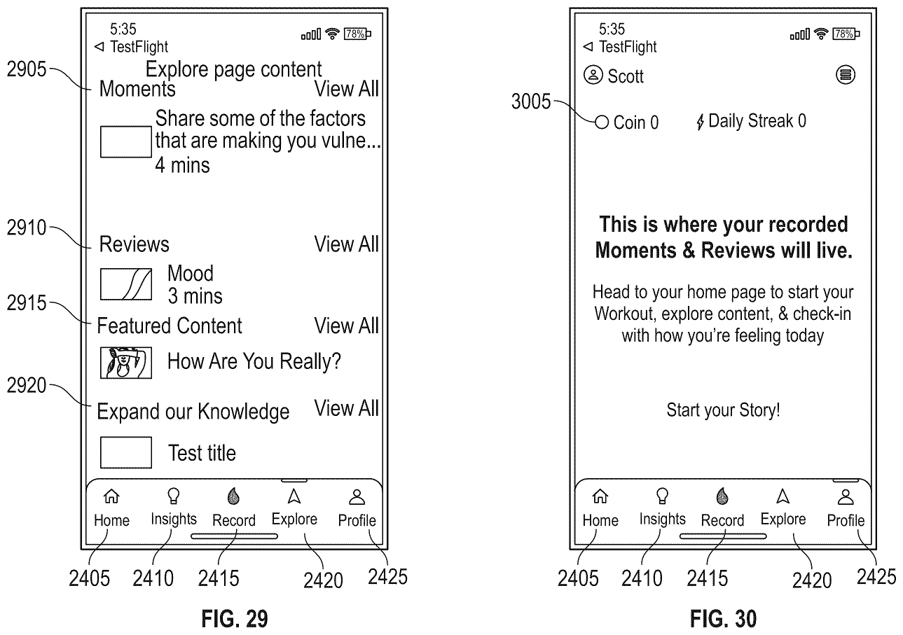

FIGS. 24-26 show a non-limiting example of a GUI for a well-being application; in this case, a GUI displaying a home screen. The home may include a set of navigation icons providing access to the home screen 2405, an insights screen 2410 (see, e.g., FIG. 27), a record screen 2415 (see, e.g., FIG. 28), an explore screen 2420 (see, e.g., FIG. 29), and a profile screen 2425 (see, e.g., FIG. 30). The home screen may include content such as a day indication 2430 and daily well-being workouts 2435 optionally including techniques, exercises, check-ins, educational materials 2440, well-being tasks 2445, and evening wind-downs 2450.

FIG. 27 shows a non-limiting example of a GUI for a well-being application; in this case, a GUI displaying an enhanced human insights (EHi) screen. The EHi screen may include one or more insights generated by the methodologies described herein.

FIG. 28 shows a non-limiting example of a GUI for a well-being application; in this case, a GUI displaying an audio and video recording studio screen. The audio and video recording studio screen may include “Audio” and “Video” selectors as well as a “Record” button 2805.

FIG. 29 shows a non-limiting example of a GUI for a well-being application; in this case, a GUI displaying an exploration screen allowing a user to browse page content. The exploration screen may provide listings of, and access to, content such as recorded user moments 2905, reviews 2910, featured content 2915 (which may be professionally curated), and educational materials 2920.

FIG. 30 shows a non-limiting example of a GUI for a well-being application; in this case, a GUI displaying a profile screen providing access to recorded moments and reviews. The profile screen may include indicators for “coin” rewards earned 3005.

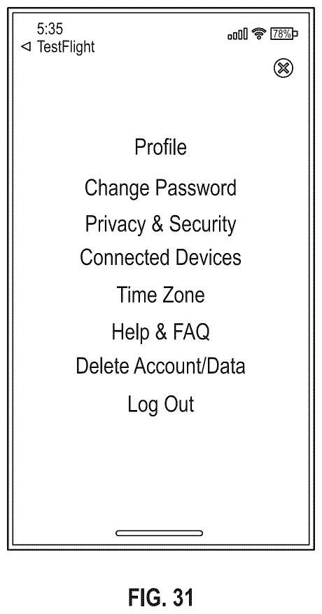

FIG. 31 shows a non-limiting example of a GUI for a well-being application; in this case, a GUI displaying a settings screen. The settings screen may provide access to settings configurations for a user, including, by way of non-limiting examples, profile settings, password settings, privacy and security settings, connected device settings, and time zone settings. The settings screen may also provide access to help screens and FAQs, tools allowing a user to delete their data and/or account, and to log-out.

### Exemplary Use Cases

### Well-being for Languishing Individuals and Populations

In various embodiments, the platforms, systems, media, and methods disclosed herein are configured for one or more use cases. In some embodiments, one or more use cases is a specific or specialized use case contemplating a particular person, group of people, or population. By way of example, there exists a middle ground between being mentally healthy and mentally ill called languishing, which is a prevalent non-clinical state. By some estimates, approximately 50% of adults are considered languishing and estimated 65% of young adults ages 18-34 are considered languishing. The longer people are in a languishing state, the greater their risk of developing mental and physical health conditions. Moreover, languishing has a compounding effect in that the longer people languish, more time is spent aimlessly searching for distraction or direction online, prompting more feelings of emptiness from social media platforms or financial strain from “quick-fix” products and services.

In some embodiments, the platforms, systems, media, and methods disclosed herein are configured for use by languishing individuals or populations. In such embodiments, the technology described herein is configured for helping users live life better by cultivating micro habits to grow and flourish, rather than providing medical treatment and/or diagnosis. The present subject matter, in some embodiments, provides a formula for helping users progress from languishing to habits of flourishing following a curiosity driven, story-focused approach, by delivering engaging strength based mental fitness training rooted in empirically based well-being science. These skills help languishing users better understand and rewrite their inner narrative, build critical resilience skills and interpret personal insights to encourage micro changes toward more positive habits. Individually tailored and linked to the future self-improvement marketplace, these insights are the impetus that connects users with additional support.

### Well-being for Students and Student Populations

By some estimates, 65% of students are considered languishing and many colleges have significant student populations at risk of dropping out due to emotional stress. In some embodiments, the platforms, systems, media, and methods disclosed herein are configured for use by individual students or student populations. In such embodiments, the technology described herein is configured to connect users with relevant third party products and services from affiliate partners who lack the disclosed depth of AI insights. In further embodiments, the rewards and reward marketplaces described here include ties into college currency and currency systems.

### In-Between Visit Support and Remote Monitoring

In some embodiments, the platforms, systems, media, and methods disclosed herein are configured for use by individuals or populations receiving care from a healthcare or mental health provider to provide in-between visit support and to provide a mechanism for remote monitoring. In such embodiments, the technology described herein is configured for helping users with mental fitness, rather than providing medical treatment and/or diagnosis.

Well-being for Individuals with Trauma and PTSD

In some embodiments, the platforms, systems, media, and methods disclosed herein are configured for use by individuals or populations with trauma and conditions such as post-traumatic stress disorder (PTSD). In such embodiments, the technology described herein is configured for helping users with mental well-being, rather than providing medical treatment and/or diagnosis.

Well-being for Individuals in Recovery from Addiction

In some embodiments, the platforms, systems, media, and methods disclosed herein are configured for use by individuals, groups, or populations with addiction, substance use disorder, or those in recovery from such conditions. In such embodiments, the technology described herein is configured for helping users with mental well-being and mental fitness, rather than providing medical treatment and/or diagnosis.

### Well-being for Displaced Populations

In some embodiments, the platforms, systems, media, and methods disclosed herein are configured for use by individuals, groups, or populations displaced due to armed conflict, generalized violence, and/or human rights violations, such as refugees and refugee populations. In such embodiments, the technology described herein is configured for helping users with mental well-being. In further embodiments, the present subject matter is configured to preserve and protect the data privacy and security of individuals while applying the disclosed algorithms to identify and predict well-being insights at a group or population level.

### Survey Platform

Because existing survey tools lack the ability to efficiently and seamlessly collect audio files for survey purposes, in some embodiments, the platforms, systems, media, and methods disclosed herein are configured as a survey platform. In such embodiments, the survey experience comprises recording audio files in response to story prompts and the platform captures, transcribes, formats, and automatically analyzes those audio files, without introducing manual workflows.

In some embodiments, the platforms, systems, media, and methods disclosed herein are deployed as a web-based platform hosted with a unique URL. In some embodiments, the technology is configured as a well-being insights platform. In other embodiments, the technology is configured as a survey platform. In yet other embodiments, the technology is configured as both a well-being insights platform and as a survey platform.

In a particular embodiment, a survey platform deployed as a web-based platform hosted with a unique URL that connects to the back-end system described herein, which allows for automated analysis of survey data. For example, an exemplary user experience starts with a survey participant engaging with the platform, the participant views survey content, and records audio files in response to story prompts. The back-end system then runs automated processes to transform the audio files into usable survey data. Specifically, when an audio file is recorded the web-based survey platform, and transmitted to the back-end system, the system conducts automated processes comprising transcribing the audio, applying algorithm models, and storing the data outputs within the back-end system.

Many survey features are suitable, including but not limited to, single-line text input (i.e., name/date fields), paragraph/multi-line text input, rich text input (i.e., text formatting, titles, headings, etc.), multiple choice questions, sliding scale questions, survey routing logic, file/image upload, drop down options, radio buttons, and the like.

In the survey platform use case of the present technology, the data output of the system is focused on generating insights to support scientific research, and not as strongly focused on providing individual-level or population-level well-being insights to participants. In a particular embodiment, the survey platform is licensed to one or more third-party organizations for the purpose of conducting surveys and generating data insights from the surveys for the purpose of scientific research.

### Wisdom Pod

In some embodiments, the platforms, systems, media, and methods disclosed herein are deployed and used, at least in part, in conjunction with a Wisdom Pod. In some embodiments, the Wisdom Pod comprises a device or machine that a user optionally enters and occupies physically. In further embodiments, the Wisdom Pod is configured to allow a user to, enter the pod, receive a prompt to view content, and record stories.

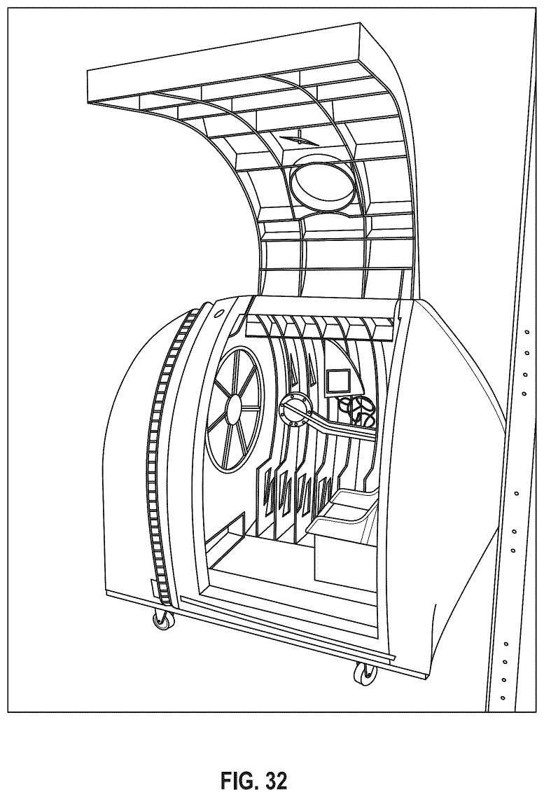

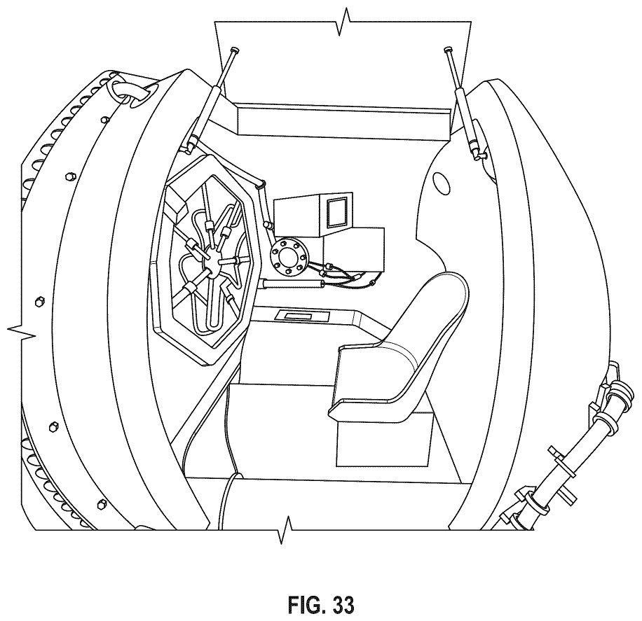

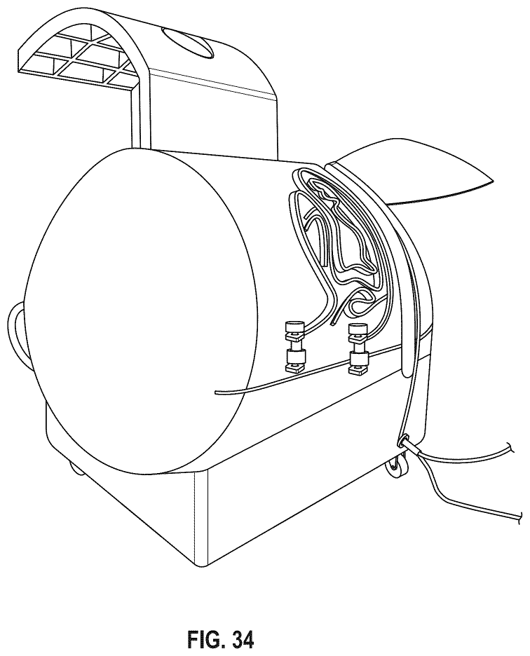

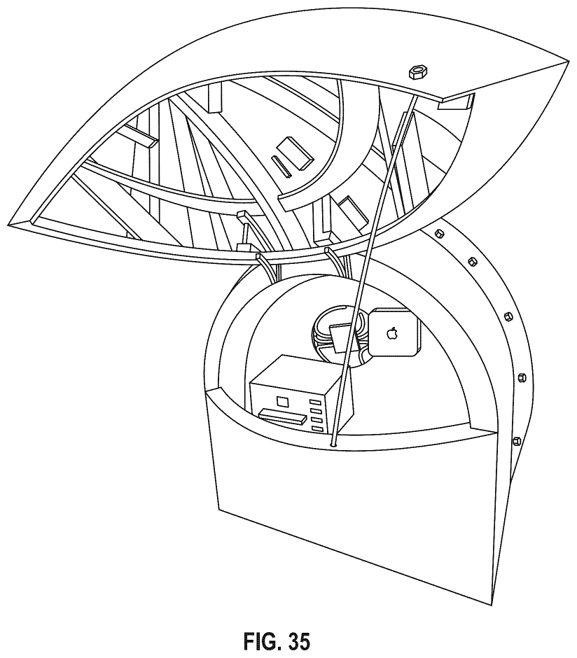

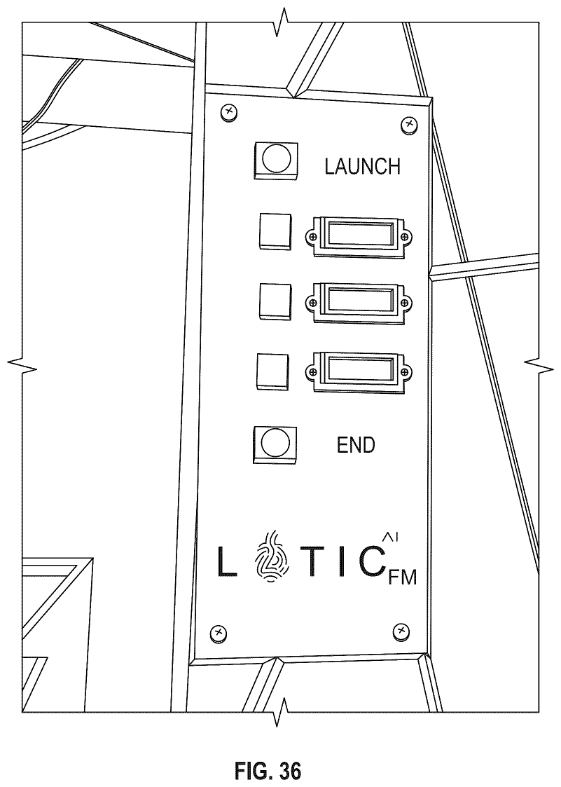

Referring to FIG. 32, in a particular non-limiting embodiment, a Wisdom Pod described herein is constructed of wood, metal, plastic, or any other safe and suitable materials, including combinations thereof. In this embodiment, the Wisdom Pod includes a body defining an interior and a first door allowing physical access to the interior. In this case, the first door opens vertically to expose the interior, which includes a seat, one or more screens, and user controls. Referring to FIG. 33, in a particular non-limiting embodiment, a Wisdom Pod described herein includes an insulated interior. Referring to FIG. 34, in a particular non-limiting embodiment, a Wisdom Pod described herein includes a first door and a second door. Referring to FIG. 35, in a particular non-limiting embodiment, a Wisdom Pod described herein includes a second door, opening vertically to provide access to computing equipment configured to allow the user to view content, record audio and/or video stories, and the like. Referring to FIG. 36, in a particular non-limiting embodiment, a Wisdom Pod described herein includes a user control panel comprising “launch” and “end” buttons.

### Wearable Device Embodiments

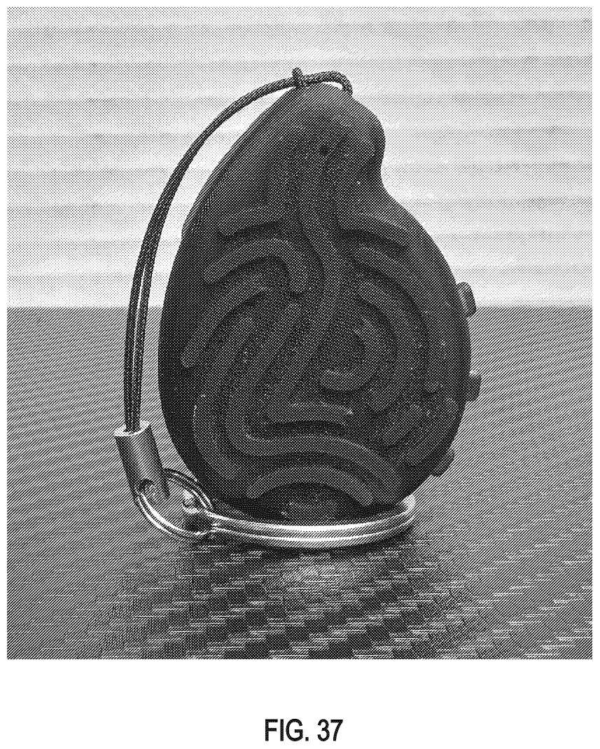

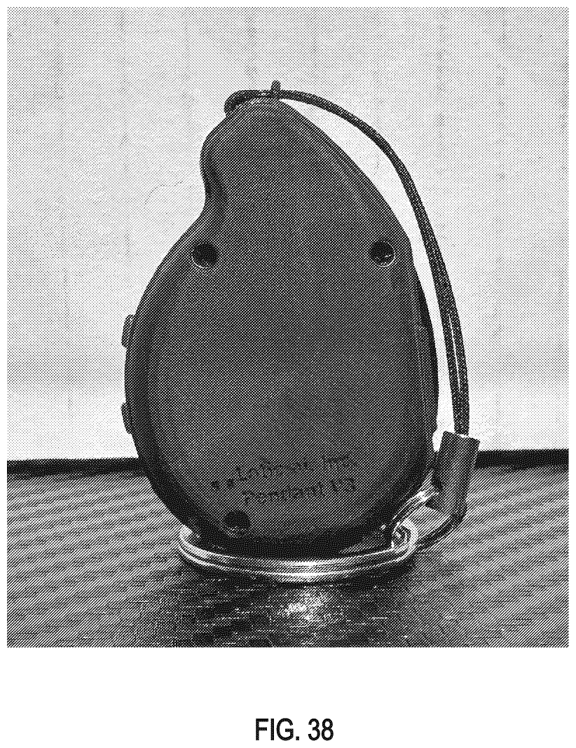

FIGS. 37 and 38 show non-limiting examples of the wearable device. Although FIGS. 37 and 38 show a certain form factor and design, embodiments are not limited thereto and these drawings are provided for exemplary purposes only, and do not limit scope.

FIG. 37 shows a non-limiting example of the front of the wearable device, in accordance with some embodiments. The wearable device may include three push buttons that can perform different functions such as record, reset, turning the wearable device on or off, etc. FIG. 38 shows a non-limiting example of the back of the wearable device, in accordance with some embodiments.

Furthermore, as shown in FIGS. 37 and 38, a hook may be installed on the top of the wearable device so that the hook may be used to attach the wearable device to a clothing or accessory of the user, such as a necklace or bracelet, or a keychain. In some embodiments, the wearable device may be placed on the inside of the user's clothing, e.g., in a pocket. In some embodiments, the wearable device may be hooked onto the rearview mirror of a car (with the mirror having another hook or keychain that the wearable device's hook can hook onto) that the user is driving.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

The terms “substantially,” “approximately,” and “about” are used throughout this disclosure, including the claims, are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

What is claimed is:

1. A wearable device for recording a story from a user, comprising:
a microphone configured to receive the story in an audio file;
a storage medium configured to temporarily store the audio file;
a transmitter configured to transmit the audio file to an external device; and
a controller configured to automatically erase the audio file from the storage medium after the audio file has been transmitted to the external device if the user has opted-in to automatic deletion.

2. The wearable device of claim 1, further comprising an attachment mechanism configured to attach or couple the wearable device to the user or a clothing or a keychain or other device held by the user, wherein the attachment mechanism comprises one of a pin, a clip, or a keychain.

3. The wearable device of claim 1, further comprising a computer-implemented system, comprising a computing device further comprising at least one processor and instructions executable to cause the at least one processor to perform operations, comprising:
receiving a story comprising an unstructured user-generated narrative;
applying an algorithm to the unstructured user-generated narrative to extract semi-structured user context data;
applying a first machine learning model to classify one or more of sentiment, intent, habits, patterns, beliefs, and motivations from at least the user context data, wherein the first machine learning model comprises an unsupervised machine learning model;
applying a second machine learning model to identify one or more recommended next actions from at least the user context data, wherein the second machine learning model comprises a supervised machine learning model; and
generating a well-being-related insight for the user based at least on the user context data, and one or more of the sentiment, intent, habits, patterns, beliefs, motivations, and one or more recommended next actions.

4. The wearable device of claim 1, wherein the controller is further configured to receive confirmation that the audio file has been validated, and wherein the validation comprises successfully transferring the story to the external device and the story being accessible by a platform on or connected to the external device.

5. The wearable device of claim 4, wherein the controller is further configured to automatically erase the audio file after the audio file has been validated if the user has opted-in to automatic deletion.

6. The wearable device of claim 1, further comprising a component configured to provide a cue, wherein the cue prompts the user to provide a story.

7. The wearable device of claim 1, further comprising a push button electrically connected to the controller, wherein the push button is configured to initiate and/or end the recording.

8. A method for recording a story from a user using a wearable device, comprising:
receiving the story in an audio format;
temporarily storing, in a storage medium, the story in an audio file;
transmitting the audio file to an external device; and
automatically erasing the audio file from the storage medium after the audio file has been transmitted to the external device if the user has opted-in to automatic deletion.

9. The method of claim 8, further comprising attaching or coupling, using an attachment mechanism, the wearable device to the user or a clothing or a keychain, or other device held by the user, wherein the attachment mechanism comprises one of a pin, a clip, or a keychain.

10. The method of claim 8, further comprising a computer-implemented method, comprising:
receiving a story comprising an unstructured user-generated narrative;
applying an algorithm to the unstructured user-generated narrative to extract semi-structured user context data;
applying a first machine learning model to classify one or more of sentiment, intent, habits, patterns, beliefs, and motivations from at least the user context data, wherein the first machine learning model comprises an unsupervised machine learning model;
applying a second machine learning model to identify a recommended next action from at least the user context data, wherein the second machine learning model comprises a supervised machine learning model; and
generating a well-being-related insight for the user based at least on the user context data, and one or more of the sentiment, intent, habits, patterns, beliefs, motivations, and recommended next action.

11. The method of claim 8, further comprising receiving confirmation that the audio file has been validated, wherein the validation comprises successfully transferring the story to the external device and the story being accessible by a platform on or connected to the external device.

12. The method of claim 11, further comprising automatically erasing the audio file after the audio file has been validated if the user has opted-in to automatic deletion.

13. The method of claim 8, further comprising providing a cue, wherein the cue prompts the user to provide the story.

14. The method of claim 8, further comprising pushing a button electrically connected to the controller to initiate and/or end the recording.

15. A non-transitory computer-readable storage media encoded with instructions executable by at least one processor for recording a story from a user using a wearable device that when executed performs a method, the method comprising:
receiving the story in an audio format;
temporarily storing, in a storage medium, the story in an audio file;
transmitting the audio file to an external device; and
automatically erasing the audio file from the storage medium after the audio file has transmitted to the external device if the user has opted-in to automatic deletion.

16. The non-transitory computer-readable storage media of claim 15, the method further comprising attaching or coupling, using an attachment mechanism, the wearable device to the user or a clothing or a keychain or other device held by the user, wherein the attachment mechanism comprises one of a pin, a clip, or a keychain.

17. The non-transitory computer-readable storage media of claim 15, further comprising:
a recording studio module configured to receive media comprising an unstructured user-generated narrative;
a user context extraction module configured to apply an algorithm to the unstructured user-generated narrative to extract semi-structured user context data;
a wisdom engine configured to:
apply a first machine learning model to classify one or more of sentiment, intent, habits, patterns, beliefs, and motivations from at least the user context data, wherein the first machine learning model comprises an unsupervised machine learning model; and
apply a second machine learning model to identify one or more recommended next actions from at least the user context data, wherein the second machine learning model comprises a supervised machine learning model; and
an insight generation module configured to generate a well-being-related insight for the user based at least on the user context data, and one or more of the sentiment, intent, habits, patterns, beliefs, motivations, and recommended next actions.

18. The non-transitory computer-readable storage media of claim 15, the method further comprising receiving a confirmation that the audio file has been validated, wherein the validation comprises successfully transferring the story to the external device and the story being accessible by a platform on or connected to the external device.

19. The non-transitory computer-readable storage media of claim 18, the method further comprising automatically erasing the audio file after the audio file has been validated if the user has opted-in to automatic deletion.

20. The non-transitory computer-readable storage media of claim 15, the method further comprising providing a cue, wherein the cue prompts the user to provide the story.
